(19) United States
(12) Patent Application Publication
(10) Pub. No.: US 2008/0276215 A1
(43) Pub. Date: Nov. 6, 2008

(54) Mask Pattern Designing Method Using Optical Proximity Correction in Optical Lithography, Designing Device, and Semiconductor Device Manufacturing Method Using the Same

(75) Inventors: Tetsuya Higuchi, Ibaraki (JP); Hirokazu Nosato, Ibaraki (JP); Masahiro Murakawa, Ibaraki (JP); Hidenori Sakanashi, Ibaraki (JP); Nobuyuki Yoshioka, Ibaraki (JP); Tsuneo Terasawa, Ibaraki (JP); Toshihiko Tanaka, Ibaraki (JP)

Correspondence Address: OBLON, SPIVAK, MCCLELLAND MAIER & NEUSTADT, P.C., 1940 DUKE STREET, ALEXANDRIA, VA, 22314, US

(73) Assignees: National Inst. of Adv. Indust. Science and Tech., Chiyoda-ku, Tokyo (JP); Runesas Technology Corporation, Chiyoda-ku, Tokyo (JP)

(21) Appl. No.: 11/910,049

(22) PCT Filed: Mar. 28, 2006
(86) PCT No.: PCT/JP2006/307022

§ 371 Date: Apr. 1, 2008

(30) Foreign Application Priority Data
Mar. 28, 2005 (JP) 2005-090299

(51) Int. Cl. G06F 17/50

(52) U.S. Cl. 716/20

(57) ABSTRACT

A method for designing a mask pattern realizes shortening the ever-growing time for the OPC treatment, decreases the fabrication TAT of a semiconductor device and cuts cost. A method for fabricating a semiconductor device uses the mask pattern designed. This invention performs the OPC treatment in advance on a cell library constituting the basic configuration of a semiconductor circuit pattern and prepares a semiconductor chip using the cell library that has undergone the OPC treatment. The method for designing a mask pattern includes the steps of designing a cell library pattern by executing for each of the cell libraries a treatment for correcting proximity effect directed to correcting the change of shape taking place during the formation of a pattern by the exposure of a mask pattern, designing a mask pattern by laying out the cell libraries and changing the amount of correction of proximity effect applied to the cell libraries in consideration of the influence of the cell library patterns disposed peripherally. This treatment for correction is executed by the degree of influence exerted by surrounding patterns collected in advance and the genetic algorithm.

### TECHNICAL FIELD

This invention relates to a mask technology for photolithography and more particularly relates to a mask pattern designing technique directed to forming a pattern even smaller than the exposure wavelength of photolithography. The invention further relates to a method for the fabrication of an electronic circuit device and a semiconductor device that use the mask pattern designing technique.

### BACKGROUND ART

The semiconductor devices are currently mass-produced by repeating a photolithographic process that comprises exposing to light a mask as an original plate having scribed a circuit pattern and causing the pattern to be transcribed to a semiconductor substrate (hereinafter referred to as a “wafer”) via an optical system to make a reduced image. In recent years, the semiconductor devices have advanced in miniaturization to such an extent that the formation of a pattern with a smaller size than the exposure wavelength of photolithography has become necessary. The pattern is influenced strongly by the diffraction when the transcription pattern is tiny and the precision of transcribed shape degrades substantially as evinced by the fact that the contour of a mask pattern is not accurately formed on a wafer and the corner part of the pattern is rounded and the length thereof is shortened. In order that this degradation may be diminished, therefore, the mask pattern is designed while it is subjected to a procedure directed to inducing inverse correction of the shape of the mask pattern. This procedure is referred to as “Optical Proximity Correction (OPC).”

The conventional OPC corrects the individual figures of the mask pattern with the model-based method using the optical simulation and the rule-based method, according to the shape thereof and the influences of the surrounding patterns. JP-A 2002-303964 (hereinafter referred to as Patent Document 1) discloses the rule-based OPC implementing pattern correction in accordance with a procedure that calculates figures in conformity with a line width and a surrounding space width and JP-A 2001-281836 (hereinafter referred to as Patent Document 2) discloses the rule-based OPC performed in accordance with a procedure that calculates the line width and the space width by performing a segment vectorization treatment and a segment sorting operation and the correction table using a hash function, JP-A 2004-61720 (hereinafter referred to as Patent Document 3) discloses the model-based OPC that incorporates the process effect achieved by the experiment of transcription.

The model-based OPC using an optical simulator continues deforming a mask pattern till a desired transcription pattern is obtained. Numerous methods with various ways of the deformation have been proposed. For example, the so-called method of sequential improvement) namely a method that thins the figure in the mask pattern when it is partially swollen in the optical image or swells it when it is partially thinned, re-calculates the optical image in the resultant mask pattern and gradually improves the mask pattern, is a famous method. The method that uses the genetic algorithm for the improvement of the mask pattern has also been proposed. The method using the genetic algorithm divides a pattern into a plurality of segments and allocates the displacements of these segments as displacement codes, and improves the displacement codes by the genetic algorithm operation to achieve the desired optical image. The method for optimizing the OPC by using this genetic algorithm is disclosed in U.S. Pat. No. 3,512,954 (hereinafter referred to Patent Document 4).

JP-A 2002-328457 (hereinafter referred to as Patent Document 5) discloses a method that alters not the whole mask layout but parts of the mask. The procedure thereof starts deciding an environmental profile for each cell to be corrected according to the presence of other figures around it. It then proceeds to read out a substituted cell name, i.e. the name of a correction pattern to be substituted in conformity with the decided environmental profile by reference to a cell substitution table and form a corrected layout data. It finally forms a mask data having completed correction by taking correction patterns corresponding to the substituted cell name. This method is at a disadvantage in adding to the cost necessary for preparation and requirement of many memory regions because it is required to decide the optimum correction patterns to be substituted with respect to all conceivable environmental profiles concerning the cells subjected to correction, give substituted cell names to the individual correction patterns, associate the environmental profile names and the substituted cell names with each other, and store them in a cell substitution table preparatorily.

The genetic algorithm (GA) is a search method based on a population genetic model and is known to possess an excellent ability to exhibit a high optimizing performance on many kinds of problems. As a reference to the GA, “Genetic Algorithms in Search, Optimization, and Machine Learning (hereinafter referred to as Non-Patent Document 1”) written by David E. Goldberg and published by Addison-Wesley Publishing Company, Inc. in 1989 may be cited.

The GA expresses the candidates of solutions of the problem with a bit array called chromosomes, performs bit operations on a population consisting of a plurality of chromosomes, and induces the chromosomes to wage a survival race. The individual chromosomes are evaluated by the target function that is the problem and the result thereof is calculated as the fitness in the form of a scalar value. The chromosomes possessing high degrees of fitness are given a chance to leave many offsprings. Further, the formation of new chromosomes is accomplished by subjecting the chromosomes in the population to crossover and mutation. The chromosomes possessing higher fitness are formed by repeating these operations and the chromosomes having the highest fitness constitute the final solution.

FIG. 1 is a flowchart showing the most fundamental procedure for the calculation of the GA. The purposes and the outlines of the individual operations are as shown below.

Initialization: The chromosomes as candidates of solution are randomly formed to give birth to a population. The problem of optimization to be solved is expressed as a evaluation function to return a scalar value.

Evaluation of chromosome: The chromosomes are evaluated using the evaluation function to calculate the fitness of each of the chromosomes.

Formation of population of next generation: The chromosomes possessing high fitness are given chances to leave many offsprings by using genetic operations (selection, crossover and mutation).

Judgment for termination of search: The evaluation of a chromosome and the formation of a population of the next generation are repeated till the conditions set in advance are fulfilled.

Now, the outline of the genetic algorithm will be described below by reference to FIG. 1.

In the “initialization” are implemented “the definition of the coding of a chromosome,” “the design of a evaluation function” and “the formation of a population of initial chromosomes.”

In the “definition of the coding of a chromosome,” the kind of contents of data and the form of inheritance to be involved when the data is passed from the chromosomes of parents to the chromosomes of offsprings during the alteration of generations are defined. FIG. 2 illustrates a chromosome. It is assumed that the component elements xi (i=1, 2, . . . , D) of the D-dimensional variable vector X=(x1, x2, . . . , xD) expressing the points in the solution space of the target problem of optimization are expressed by an array of M symbols Ai (i=1, 2, . . . , M) and the resultant variable vector is regarded as a chromosome composed of (D×M) genes. As the value Ai of a gene, the set of certain integers, the value of real number within a certain range, and the array of symbols may be used, depending on the nature of the problem to be solved. FIG. 2 depicts an example of expressing the component variables of one of the candidates of solution of the 5-dimensional, namely 5-variable (namely D=5), problem of optimization by using four (namely M=4) of the symbols of two kinds (0, 1). The array of genes thus symbolized constitutes a chromosome.

The “design of a evaluation function” defines the method for calculating the fitness that expresses the degree with which a given chromosome adapts itself to the environment. The design involved herein is directed to enabling the chromosome corresponding to the variable vector excelling as a solution of the problem of optimization to obtain high fitness.

In the “formation of the population of initial chromosomes,” N chromosomes are randomly formed generally in accordance with the rule decided by “the definition of the coding of a chromosome.” This is because the characteristics of the problem of optimization to be solved are not clear and the question as to what kinds of chromosome is excellent is utterly indistinct. When the foreknowledge of some sort exists regarding the problem, however, the speed and the precision of the search may possibly be enhanced by inducing formation of a population of chromosomes centering around a region that is expected to exhibit a high degree of fitness in the solution space.

In the “evaluation of a chromosome,” the fitness of each of the chromosomes in the population is calculated based on the method defined by the preceding section “design of a evaluation function.”

The “formation of a population of the next generation” induces formation of the population of chromosomes of the next generation by subjecting the population of chromosomes to genetic operations based on the fitness of each of the chromosomes. The typical procedures of the genetic manipulation include selection, crossover and mutation. They will be collectively referred to as the genetic operations.

The “selection” implements an operation that comprises extracting chromosomes of high fitness from the population of chromosomes of the current generation, leaving them in the population of the next generation and conversely removing chromosomes of low fitness.

The “crossover” constitutes an operation that comprises randomly selecting chromosome pairs with a prescribed probability from among the group of chromosomes extracted by the selection and recombining part of their genes, thereby producing new chromosomes.

In the “mutation,” chromosomes are randomly selected with a prescribed probability from among the group of chromosomes extracted by the selection and the randomly chosen genes are altered with a prescribed probability. Here, the probability with which the mutation is developed is referred to the mutation rate.

In the “judgment for termination of search,” the formed population of chromosomes of the next generation is investigated to determine whether it satisfies the criteria for terminating the search. When the criteria are satisfied, the chromosome that exhibits the highest fitness at that point of time in the population of chromosomes is nominated as the solution of the target problem of optimization. When the condition for termination is not satisfied, the treatment of “evaluation of a chromosome” is resumed and the search is continued. The criteria for terminating the operations of search depend on the nature of the problem of optimization to be solved. The typical criteria are as shown below.

The largest fitness among the population of chromosomes surpasses a certain threshold.

The average fitness of the whole population of chromosomes surpasses a certain threshold.

The rate of increase of the fitness of the population of chromosomes continues past a fixed duration in the generation below a certain threshold.

The number of alterations of generations reaches a predetermined number of times.

The conventional OPC method that uses the genetic algorithm described above, corrects the shapes of all the figures of a mask defining the circuit pattern of a semiconductor chip. The increased number of figures in consequence of miniaturization, therefore, results in making the time spent for the treatment to grow enormous. The case of a 90-nm node device actually requiring time of several tens of hours has been reported. Because of the decline of the exposure contrast due to the formation of a pattern with the resolution extreme for exposure, any greater miniaturization compels the OPC to become more complicated and entail the increased number of figures. In the case of a 65-nm node device, the time required for the development of a mask pattern has come to amount even to several days. Since the product cycle of the semiconductor devices has been shortening meanwhile, the reduction of the time for the OPC treatment has been a serious task.

The increase of the time for the OPC process has resulted in deteriorating the production TAT (turn around time) of a semiconductor device inclusive of the development of a mask pattern and boosting the cost as well.

A task of this invention, therefore, is to provide a method for designing a mask pattern by means of an OPC process that realizes a reduction in the everlasting increase of the time for the OPC process, shortening the production TAT of a semiconductor device, and cutting the cost.

Another task of this invention is to provide a method for fabricating an electronic circuit device and a semiconductor device that enables developing a mask pattern in a practical duration and permits shortening the duration of fabrication.

Still another task of this invention is to provide a semiconductor device having a short duration of fabrication.

### DISCLOSURE OF THE INVENTION

The means for solving the task of this invention comprises subjecting a cell library pattern constituting the basic configuration of a semiconductor circuit pattern preparatorily to an OPC operation and using the cell library pattern that has undergone the OPC operation to fabricate a semiconductor chip. At this time, the cell library pattern having undergone the preparatory OPC treatment is required to be corrected (and optimized) because it is affected by the cell library patterns surrounding it. The correction of the cell library pattern is executed by the genetic algorithm according to the degree of influence of the surrounding patterns collected in advance and. Since there are several hundred kinds of the cell library patterns, the combinations of the surrounding cell library patterns total an enormous number. The method of correction that utilizes a correction table resulting from combining the relevant cell library pattern with the surrounding cell library patterns does not suit practical use on account of the duration of process and the complexity of management. In contrast, the method for optimization that resorts to the genetic algorithm is excellent as a method capable of speedily optimizing the enormous number of combinations. This method of optimization allows shortening the time required for the correction as compared with the conventional OPC to be performed on all the patterns because the use of this method results in expediting the correction. This is because the number of component steps of the method is small and the method suits a parallel processing.

The method of this invention for designing a mask pattern comprises the steps of acquiring cell libraries having undergone the treatment of optical proximity correction directed to correcting the change of shape taking place during the formation of a pattern by exposure to light of a mask pattern, laying out the cell libraries to design a mask pattern and changing the amount of the optical proximity correction given to the cell libraries in consideration of the influence of cell library patterns laid out peripherally.

In the method of this invention for designing a mask pattern, the step of designing the mask pattern comprises a step of defining and registering a variable to be adjusted for the purpose of implementing the optical proximity correction.

The method of this invention for designing a mask pattern further comprises the steps of comprehending the degree of influence of surrounding patterns and optimizing the variable, thereby treating the cell libraries for correction.

In the method of this invention for designing a mask pattern, the step of optimizing the variable is effected by the genetic algorithm method.

The computer program of this invention consists of an algorithm possessing a function of executing any one of the preceding methods for designing a mask pattern.

The semiconductor device of this invention is fabricated using the mask pattern formed by any one of the preceding methods for designing a mask pattern.

The method of this invention for manufacturing an electronic circuit device comprises using the mask pattern formed by any one of the preceding methods for designing a mask pattern.

The method of this invention for designing a mask pattern further comprises the step of changing the peripheral region of a single cell having undergone the treatment of optical proximity correction in consideration of the influence of peripherally disposed cell library patterns.

The method of this invention for fabricating a semiconductor device comprises using a mask pattern whose gate pattern has been corrected by any one of the preceding methods for designing a mask pattern.

In the method of this invention for fabricating a semiconductor device, the gate pattern has an adjusting variable that is a gate width and/or a gate length.

The method of this invention for fabricating a semiconductor device comprises using a mask pattern whose isolation-forming pattern has been corrected by any one of the preceding methods for designing a mask pattern.

Further, in the method of this invention for fabricating a semiconductor device, the isolation-forming pattern has an adjusting variable that is the width of an active region (diffusion layer region), the amount of retraction, the amount of projection or the combination thereof.

The method of this invention for fabricating a semiconductor device comprises the step of using a mask pattern whose contact pattern has been corrected by any one of the preceding methods for designing a mask pattern.

Further, in the method of this invention for fabricating a semiconductor device, the contact pattern has an adjusting variable that is the height, the width and the central position.

Still further, the method of this invention for fabricating a semiconductor device comprises the steps of using a mask pattern formed by any one of the preceding methods for designing a mask pattern and using a single-wafer processing.

The conventional OPC treatment has been executed for all the figures of a mask defining the circuit pattern of a semiconductor chip and, therefore, has been at a disadvantage in suffering the duration of treatment to grow enormous owing to the increased number of figures in consequence of miniaturization. In contrast, this invention described above permits a substantial decrease of the duration of treatment by first performing the OPC process on individual cells as a unit, configuring the whole figure of a mask by combining such cells, and performing the OPC adjustment between the cells in the whole figure of the mask.

The OPC treatment of the cell unit can be executed to a certain extent by the existing technique. When it is retained as a library in advance, therefore the duration of the OPC process is substantially accounted for mainly by the OPC adjustment between the cell units. This invention allows a substantial decrease of the number of combinations (number of parameters) as compared with the case of executing the OPC process on the whole figure and, therefore, enables substantially decreasing the duration of the restriction imposed on the optimization.

The use of the method and the apparatus of this invention for designing a mask pattern in the optical proximity correction of the photolithography results in expediting and facilitating the mask pattern design of a large scale integrated circuit in the method for fabricating a semiconductor device. It, therefore, acquires a prominent effect of curtailing the time for producing the mask pattern and rendering the manufacture inexpensive.

### BRIEF DESCRIPTION OF THE DRAWINGS

FIG. 1 is a flowchart illustrating the procedure of genetic algorithm.

FIG. 2 is an explanatory view illustrating one example of the expression of a chromosome to be used for the method of this invention for the OPC treatment.

FIG. 3 is a schematic view illustrating a mask pattern used in the gate of an SRAM to which this invention is applied for the purpose of verifying the effectiveness of this invention.

FIG. 4(a) to FIG. 4(j) are schematic views illustrating mask patterns P1 to P10, respectively, used for the verification of this invention.

FIG. 5 is a schematic view illustrating an example of the transcription pattern of the mask patterns illustrated in FIG. 4(a) to FIG. 4(j) and portions of measurement.

FIG. 6(a) is a schematic view illustrating an exposure pattern example of the mask pattern P1 shown in FIG. 4(a).

FIG. 6(b) is a schematic view illustrating an exposure pattern example of the mask pattern P3 shown in FIG. 4(c).

FIG. 7 is an enlarged view of the mask pattern P3 shown in FIG. 4(c).

FIG. 8 is an enlarged view of the mask pattern P1 shown in FIG. 4(a).

FIG. 9 is a schematic view illustrating the portions for setting the optimization parameters of the mask patterns P1 and P3 of FIG. 4(a) and FIG. 4(c).

FIG. 10(a) is a schematic view illustrating symbols of the NAND gate.

FIG. 10(b) is a plan view illustrating the circuit diagram of the NAND gate of FIG. 10(a).

FIG. 10(c) is a plan view illustrating the pattern layout of the NAND gate of FIG. 10(a).

FIG. 11 is a schematic view illustrating a broken line defining a unit logic cell and a cross section in the pattern layout of the NAND gate shown in FIG. 10(c).

FIG. 12(a) to FIG. 12(f) are schematic views illustrating mask patterns used during the formation of the unit logic cell shown in FIG. 11.

FIG. 13(a) to FIG. 13(e) are cross sections taken along the broken line in FIG. 11 to depict collectively a process chart illustrating the component steps sequentially up to the step for separating a device.

FIG. 14(a) to FIG. 14(e) are cross sections taken along the broken line in FIG. 11 to depict collectively a process chart illustrating the component steps sequentially up to the step for forming a channel.

FIG. 15(a) to FIG. 15(e) are cross sections taken along the broken line in FIG. 11 to depict collectively a process chart illustrating the component steps sequentially up to the step for forming part of a wiring.

FIG. 16 is a schematic view illustrating the configuration of the mask pattern of the mask M4 shown in FIG. 12(d).

FIG. 17 is a schematic view illustrating an example of genetically expressing the differential size from the design target in FIG. 16.

FIG. 18 is a schematic view illustrating an example of grouping cells based on the relative positions.

FIG. 19 is a schematic view illustrating the portions for measuring sizes for determining the fitness of a chromosome.

FIG. 20 is a schematic view illustrating a differential image between a design pattern and a resist pattern.

FIG. 21 is a diagram showing a process flow for fabricating a semiconductor device.

FIG. 22 is a schematic view illustrating a cell in a cell library having undergone the OPC performed on individual cells as a unit.

FIG. 23 is an enlarged view of the cell in FIG. 22.

FIG. 24 is a schematic view illustrating an actual example of the adjusting variable of the gate width w1.

FIG. 25 is a schematic view illustrating an actual example of adjusting variables of mating allowances d1 and d2 between a contact layer and a diffusion layer.

FIG. 26 is a schematic view illustrating an actual example of the evasion of resolution failure (failure of pattern connection) between neighboring cells.

FIG. 27 is a schematic view illustrating an example of the evasion of failure of the gate wiring running aground the diffusion layer.

FIG. 28 is a schematic view illustrating the regions of the repeated OPC adjustment of the gate length, the resolution failure (failure of pattern connection) evasion allowance s4 with the neighboring cells, the failure evasion allowance s3 of the gate wiring running aground the diffusion layer, and the amount of projection p1 from the active region.

FIG. 29(a) and FIG. 29(b) are schematic views illustrating examples of the adjusting variable of the gate length l1.

FIG. 30 is a schematic view illustrating an example of the evasion of the resolution failure (failure of pattern connection) with the neighboring cells.

FIG. 31 is a schematic view illustrating an example of the evasion of the failure of the gate wiring running aground the diffusion layer.

FIG. 32(a) to FIG. 32(c) are schematic views illustrating examples of the correction of the projection from the active region.

FIG. 33 is a schematic view illustrating a layout example of the contact layer.

FIG. 34 is a schematic view illustrating an example of the adjusting variable of a contact pattern.

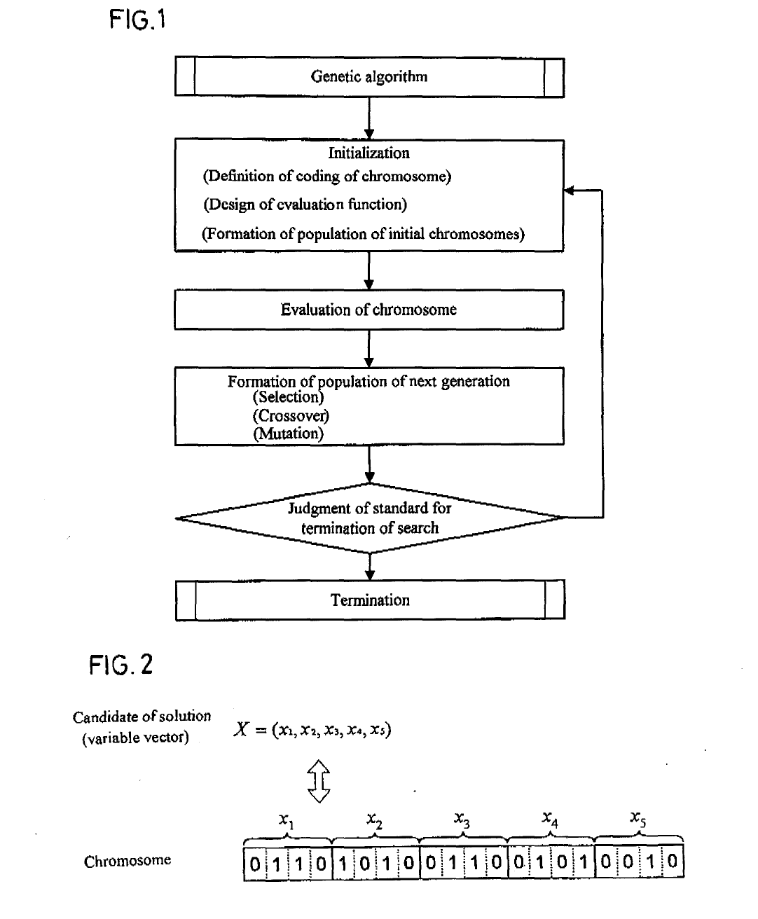

### BEST MODE FOR CARRYING OUT THE INVENTION

Now, the embodiments of this invention will be described in detail below by reference to the drawings. In the following description, the devices endowed with the same or similar functions will be denoted by the same symbols unless there exists a special reason.

### First Embodiment

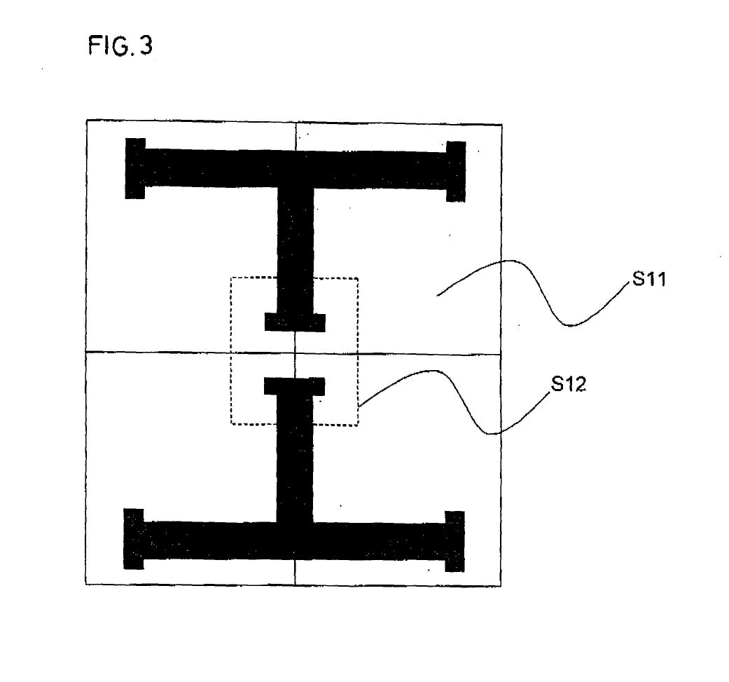

For the purpose of verifying the effectiveness of this invention, one of the mask patterns used in the gate of SRAM shown in FIG. 3 was adopted as a cell and this invention was applied to the cell. First, a verifying experiment intended to determine whether a neighboring environment influences the transcription of a mask pattern was carried out. Then, the method of this invention for designing a pattern by means of a genetic algorithm was applied to the pattern exhibiting the strongest influence in all the patterns, by way of a verifying experiment intended to determine whether the method is capable of accomplishing optimization. In the following experiment, the verification was implemented under the lithographic conditions shown in Table 1,

TABLE 1

| Set name | Set value |
|---|---|
| λ | 193 nm |
| NA | 0.7 |
| σ | 0.85/0.55 (annula) |
| Line-width | 90 nm in width |
| Slice level | 0.298 |

Incidentally, the aforementioned transcription pattern was formed in accordance with the optical simulation software. The software made by Litho Tech Japan Corporation and sold under the trademark designation of “SOLID-C” is renowned and is universally known to persons skilled in the art (refer to URL: http://www.ltj.co.jp/index.html).

### (Verifying Experiment 1)

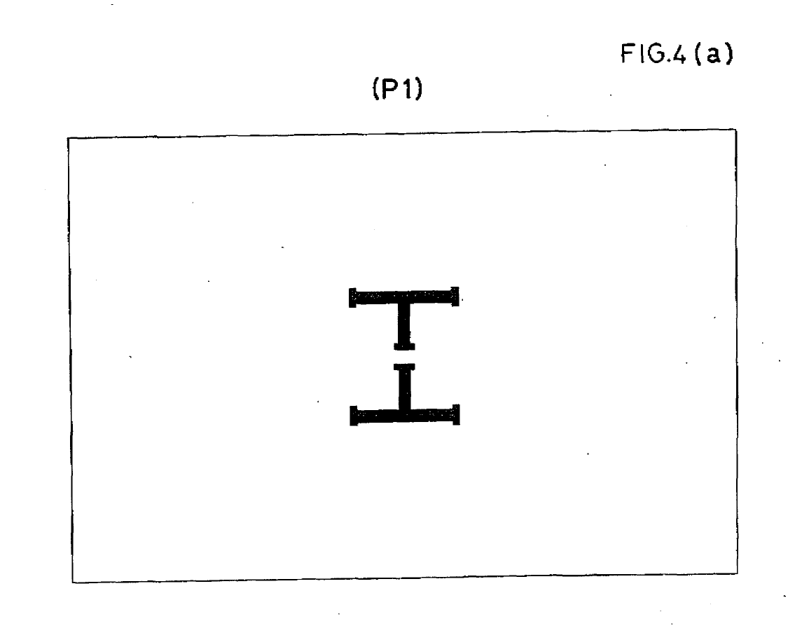

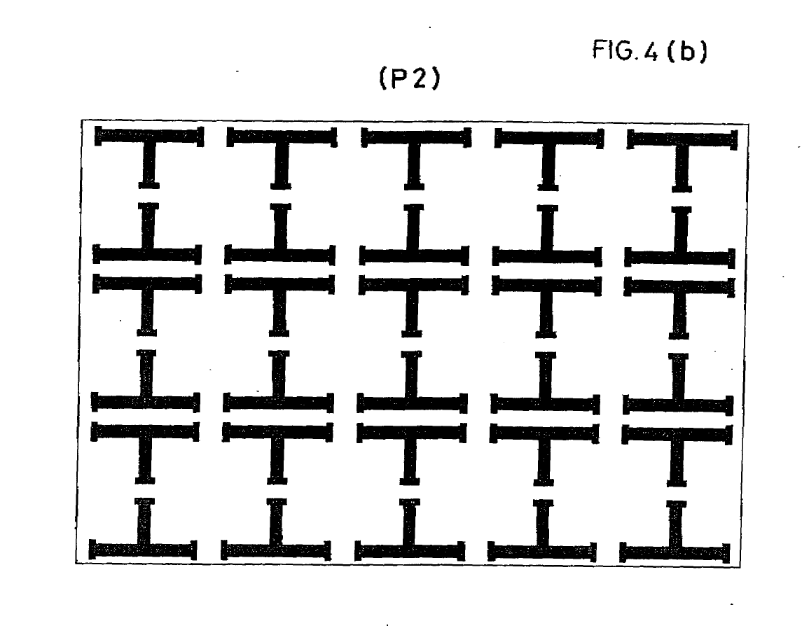

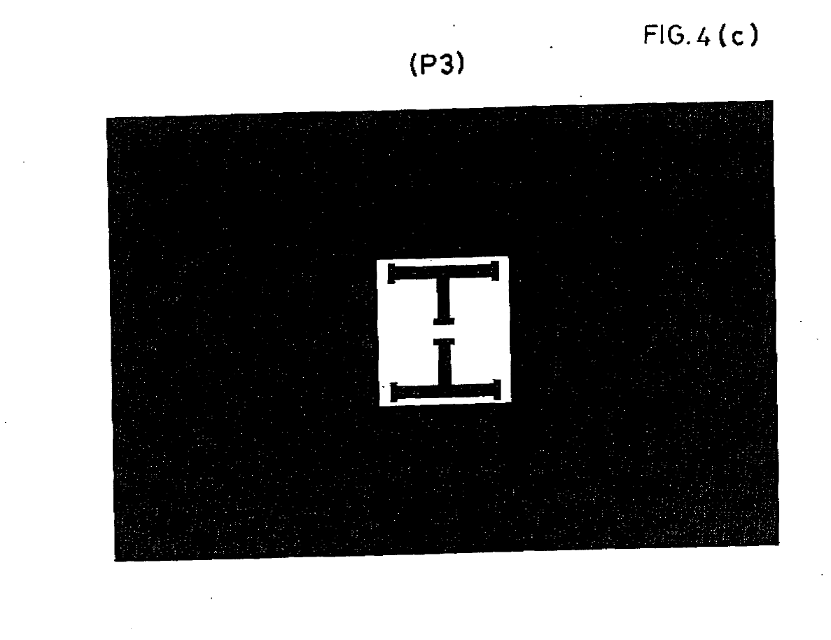

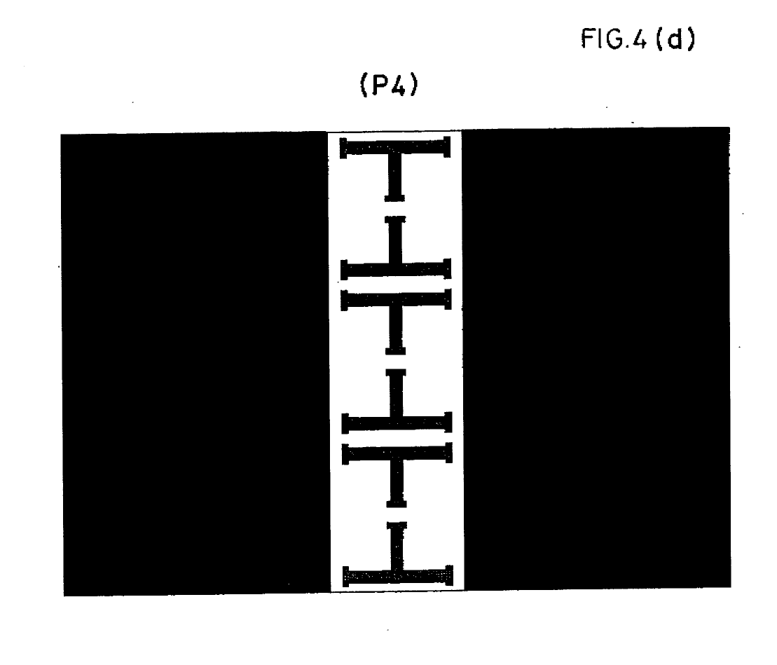

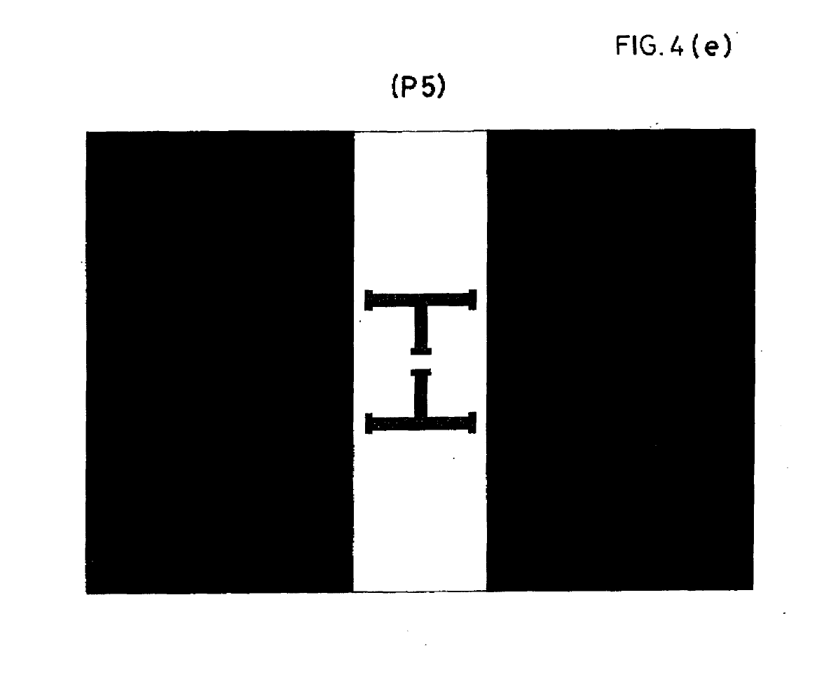

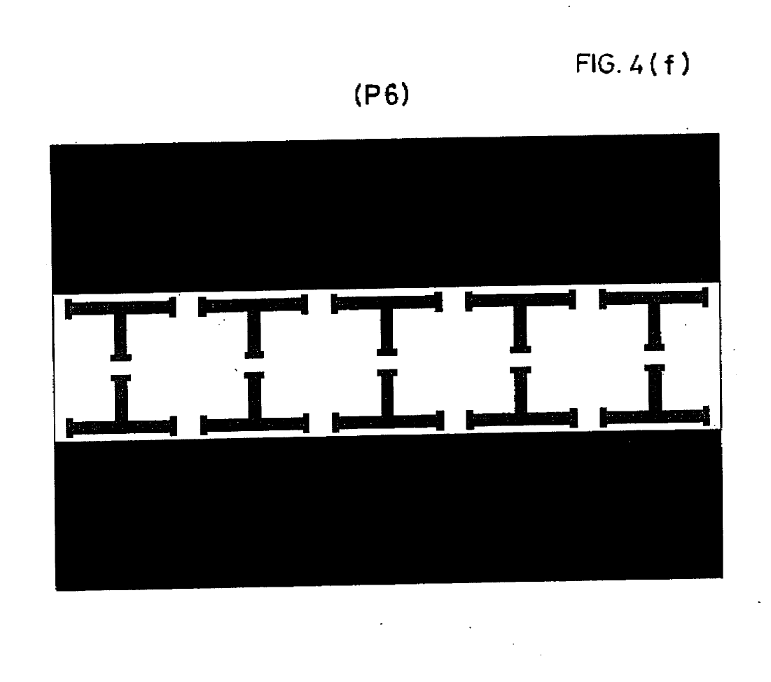

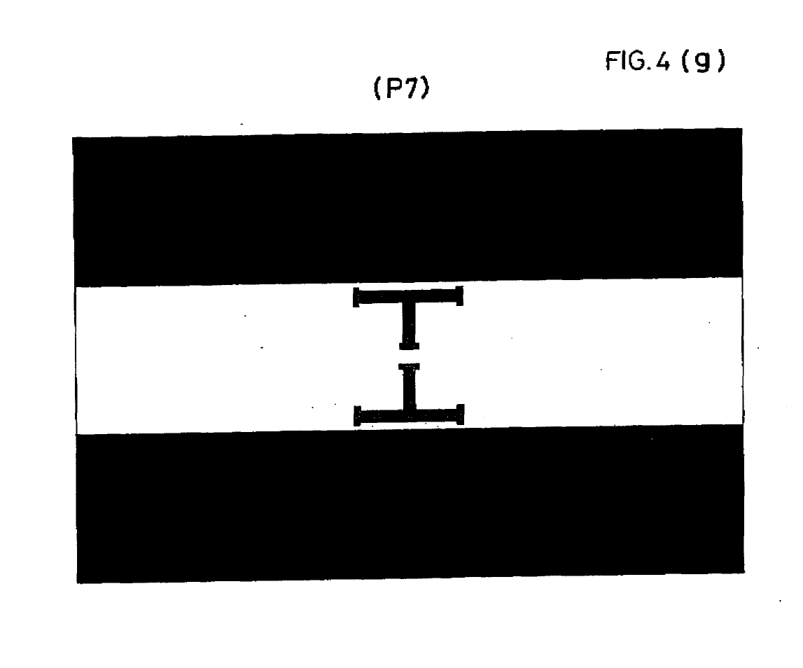

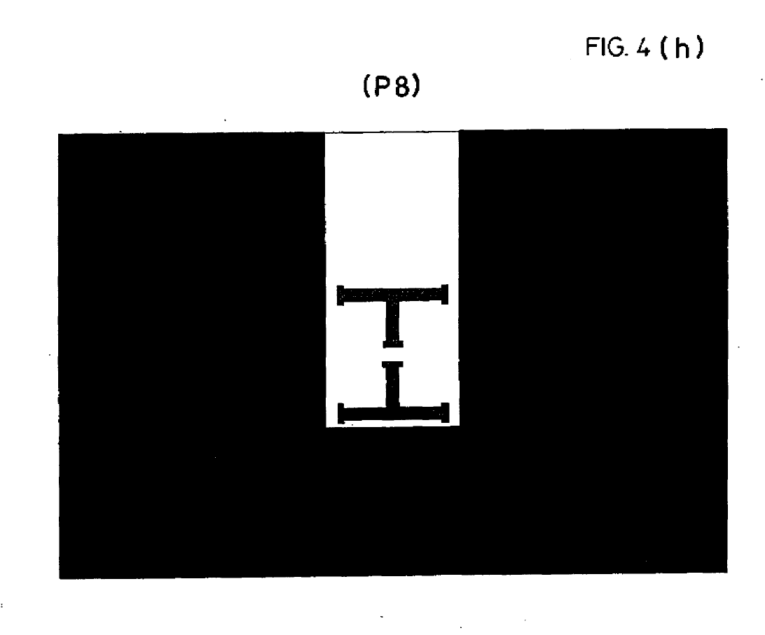

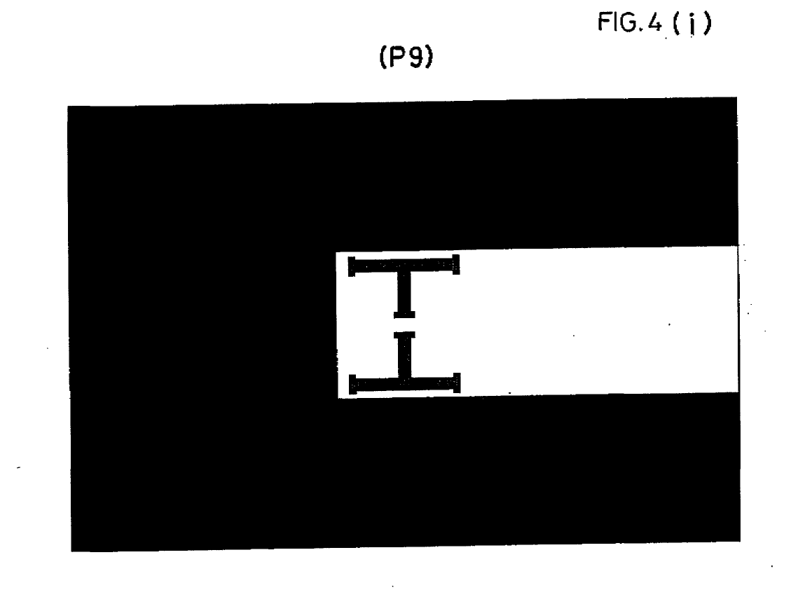

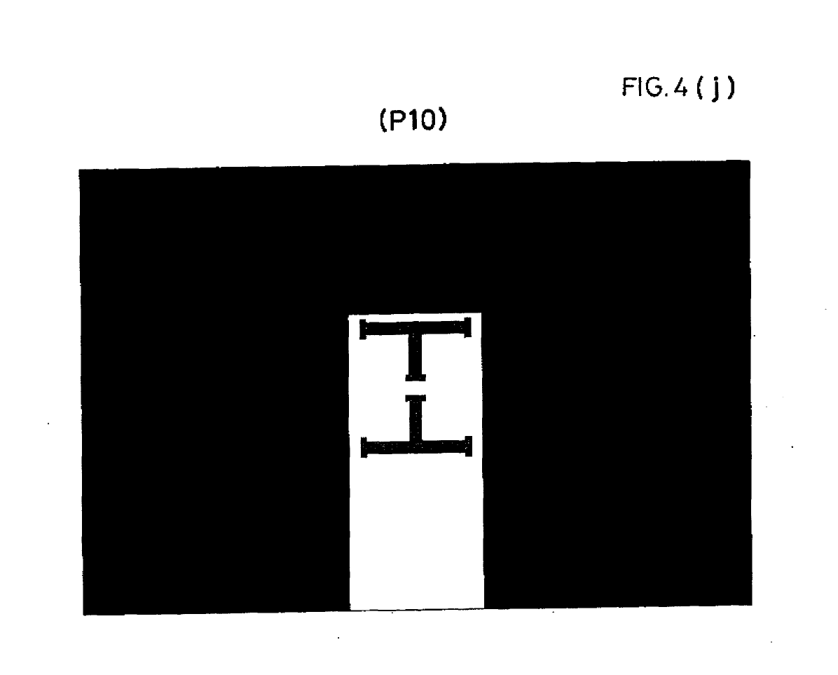

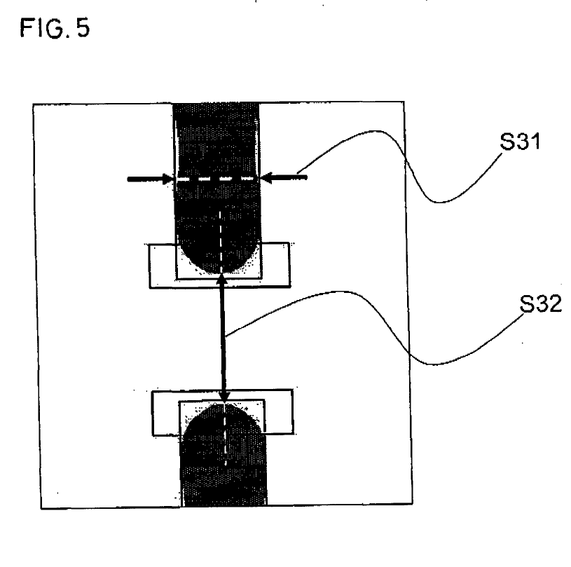

First, a verifying experiment intended to determine whether the mask pattern is influenced by a change in the surrounding environment was carried out. FIG. 4(a) to FIG. 4(j) respectively show the mask patterns P1 to P10 used in the verification. Since the ten mask patterns were designed in a width of 90 nm, the ideal line width was 90 nm. In the present experiment, the influence of the surrounding environment was verified by preparing these transcription patterns and comparing them with the two values, the width A (S31) and the gap B (S32) shown in FIG. 5 (magnification of S12 of FIG. 3), serving as the evaluation values.

Table 2 shows the two evaluation values of the transcription patterns of the mask patterns P1 to P10,

TABLE 2

| Set name | S31 (nm) | S32 (nm) |
|---|---|---|
| Target value | 90.00 | 142.0 |
| P1 | 89.90 | 142.0 |
| P2 | 85.50 | 146.1 |
| P3 | 73.90 | 161.1 |
| P4 | 77.50 | 157.7 |
| P5 | 79.64 | 156.7 |
| P6 | 82.30 | 148.5 |
| P7 | 84.12 | 146.7 |
| P8 | 78.76 | 158.9 |
| P9 | 75.61 | 154.5 |
| P10 | 74.48 | 158.9 |

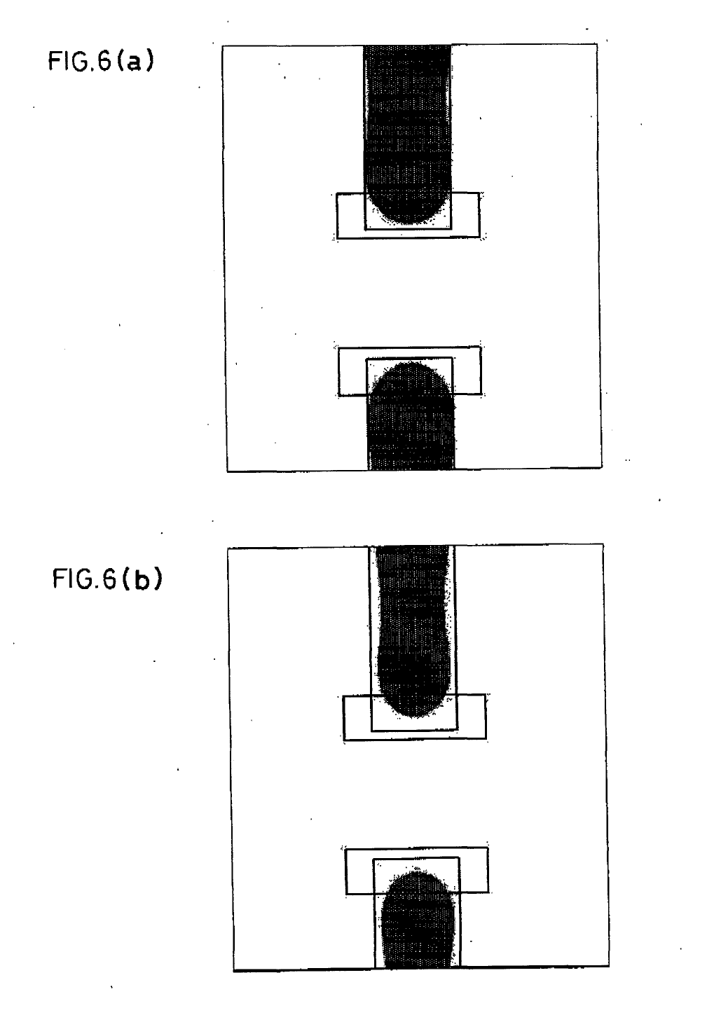

While the pattern P1 assumed an ideal line width because of utter absence of the influence of a surrounding environment, the patterns P2 and P3 suffered a large influence from a surrounding environment and clearly showed large deviations in the line width S31 and the gap S32 thereof as compared with the pattern P1. FIG. 6(a) and FIG. 6(b) respectively show the transcription patterns of the ideal pattern P1 and the pattern P3 suffering the largest influence. It is clear that the pattern P3 sustained a large influence not only on the line width S31 or the gap S32 but wholly. Comparison of the evaluation values of the other patterns clearly reveals that the degrees of influence exerted on the transcription patterns of the individual patterns were varied by a difference in a surrounding environment. Since the actual mask pattern is used in a form resulting from combining various cells, the component cells are expected to produce a very large and complicated influence. Even in the cell pattern that is fixed in design, therefore, the OPC mask adapted to a surrounding environment indispensably necessitates complicated optimization,

### (Verifying Experiment 2)

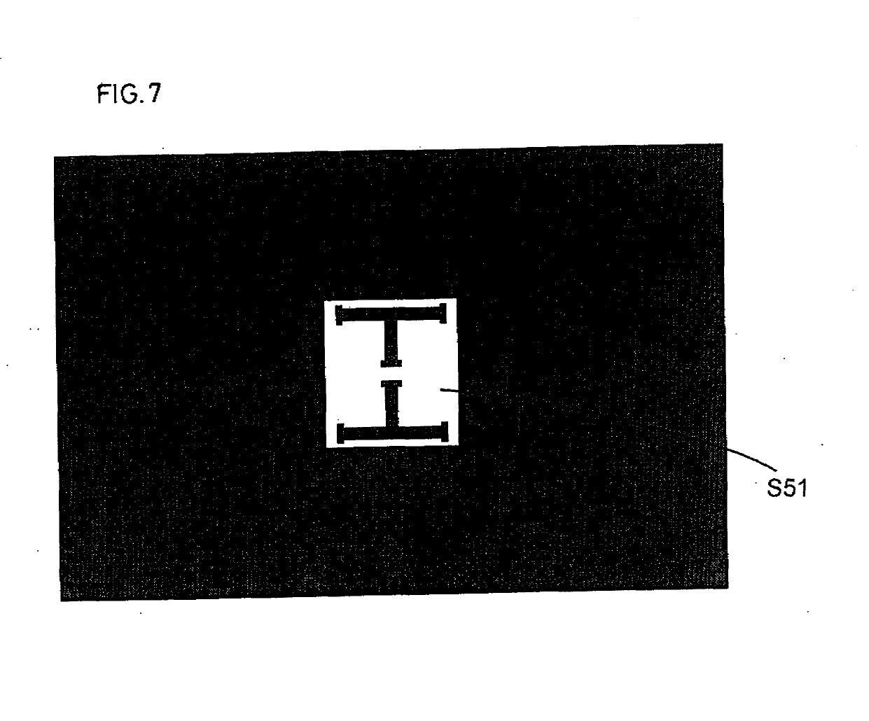

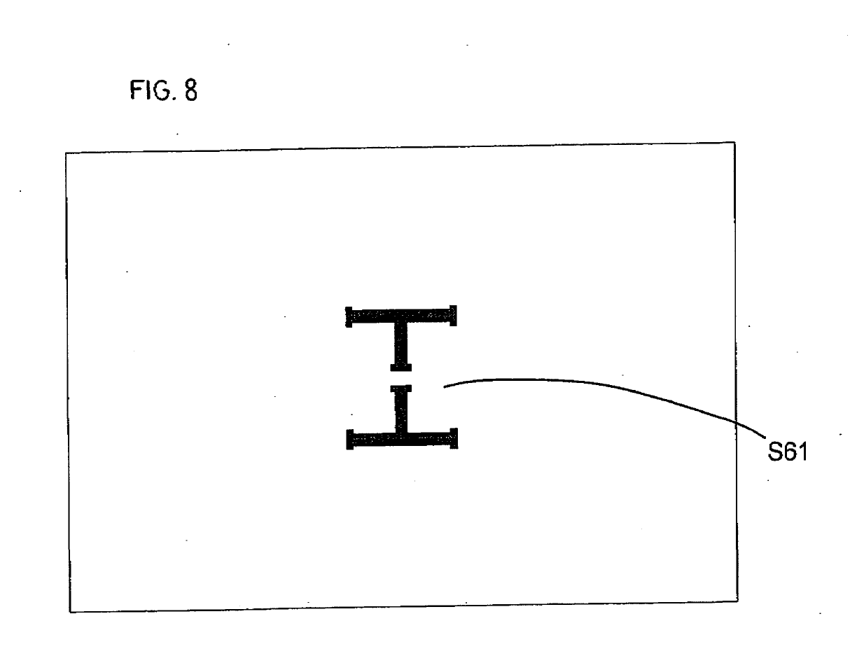

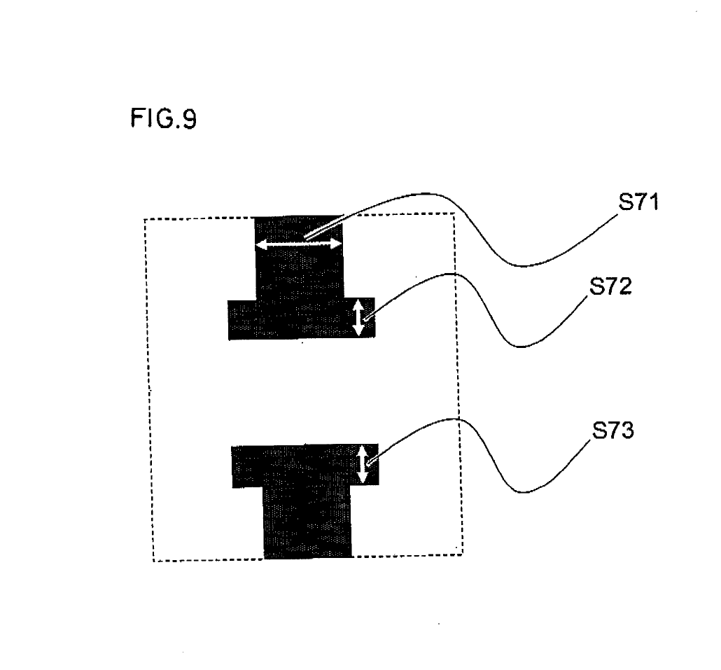

A verifying experiment intended to determine whether the influence by a surrounding environment verified by the verifying experiment 1 can be solved by the method of this invention was carried out. In this verifying experiment, as the simplest example, a simulation intended to optimize the mask pattern P3 (FIG. 7) demonstrating the greatest influence in the verifying experiment 1 toward the most ideal mask pattern P1 (FIG. 8) as the target was carried out. In this simulation, the optimization by the method of this invention was implemented while the two portions S71 and S72 in the cell shown in FIG. 9 (the magnified transcription pattern of S12 of FIG. 3) were used as the optimizing parameters.

Now, the method for applying the genetic algorithm will be described below. Since the procedure for calculating the genetic algorithm is as described in the preceding section of the “Background Art,” the component steps of the procedure will be described in detail here.

### [Initialization: Definition of Coding of Chromosome]

In this simulation, the variable vector X is regarded as a two-dimensional vector like X=(x1, x2) and the component elements xi (i=1, 2) is expressed with real numbers because S71 and S72 shown in FIG. 9 are used as the optimizing parameters. Incidentally, it is assumed that S73 always assumes the same value as S72.

### [Initialization: Design of Evaluation Function]

Since the fitness cannot be defined with an explicit function, the procedure for calculating the fitness that consists of the following four steps is adopted.

Step (1): A figure pattern is re-configured using a variable vector uniquely fixed by a chromosome.

Step (2): An exposure pattern is calculated carrying out optical simulation.

Step (3): With respect to the exposure pattern so calculated, the sizes of S31 and S32 in FIG. 5 are measured and the sum of the errors of the resultant measurements from the design value is calculated.

Step (4): Since the target set herein resides in acquiring an exposure pattern infinitely approximating the design value, the errors are preferred to be as small as possible. Thus, the reciprocal of the sum of the errors found by the measurement is adopted as the fitness.

### [Initialization: Formation of Population of Initial Chromosomes]

In accordance with the rule decided in the foregoing section “Initialization: Definition of coding of a chromosome,” the vector that is composed of two elements of a real-number value is adopted as a chromosome. On the assumption that the number N of chromosomes is 100, 100 chromosomes are randomly formed by means of a pseudo-random number generator.

### [Evaluation of Chromosome]

In accordance with the procedure for evaluating a chromosome that is decided by the foregoing section “Initialization: Design of evaluation function,” all the chromosomes are evaluated and the degrees of fitness thereof are calculated.

### [Formation of Population of Next Generation: Selection]

In the present embodiment, the roulette selection is used. This method resides in causing the probability with which the individual chromosomes are allowed to survive in the next generation to become proportional to the fitness. That is, when the fitness is high, the number of slots on the roulette wheel grows proportionately and the probability with which the slots are hit while the roulette wheel is in rotation increases correspondingly. To be specific, the target herein is attained by repeating up to N times the procedure for extracting the individual chromosomes with the probability of (Fi÷Σ) on the assumption that N denotes the size of the population of chromosomes, Fi the degree of fitness of the i-th chromosome and Σ the summation of the degrees of fitness of all the chromosomes. In the foregoing case, since the number of chromosomes is 100, the repetition up to 100 times results in selecting 100 chromosomes of the next generation.

### [Formation of Population of Next Generation: Crossover]

In the present embodiment, the uniform crossover is used. This method resides in selecting two chromosomes from each of the populations of chromosomes and randomly deciding whether the variable as a gene in the individual gene loci is exchanged or not. To be specific, the two selected chromosomes that are respectively represented as X¹=(x¹₁, x¹₂) and X²=(x²₁, x²₂) are subjected twice to the development of random numbers outputting 0 or 1 with the probability of ½. The random numbers of the first development belong to the first gene locus and they exchange x¹₁ and x²₁ when the number is 1 and they make no exchange when the number is 0. The procedure performed on the second gene locus is similar.

### [Formation of Population of Next Generation: Mutation]

The present embodiment adopts the procedure for totaling the random numbers produced in accordance with the regular distribution with respect to the gene loci selected out with the mutation ratio P_{M} conforming to the uniform distribution. Here, the mutation ratio P_{M}=1/50, the average of the normal distribution u=0, and the standard deviation σ=5×10⁻⁹ are set.

### [Criteria for Termination of Search]

In the present embodiment, it is assumed that the search is terminated when the chromosome that has no error from the design value is detected or when the evaluation of a chromosome is performed up to 5000 times.

In the verifying experiment implemented by using the genetic algorithm described above, the results shown in Table 3 were obtained by optimizing the parameter shown in FIG. 9. From Table 3, it is clear that the width S31 of the transcription pattern formerly narrowed in the surrounding environment of FIG. 7 by about 16 nm as shown in Table 2 of the verifying experiment 1 was optimized to about 90 nm, an ideal width of FIG. 8, by the method of this invention.

TABLE 3

| | | P1 | P3 |
|---|---|---|---|
| Portion of adjustment | S71 | 90.00 nm | 105.00 nm |
| | S72 | 48.00 nm | 55.00 nm |
| Result of evaluation | S31 | 89.94 nm | 89.76 nm |
| | S32 | 142.40 nm | 142.10 nm |

By this experiment, it has been ascertained that the method of this invention is capable of optimizing the deviation of the transcription pattern induced by the influence of the surrounding environment during the design of a mask pattern.

Incidentally, the present embodiment has described the case of using the simple sum of the errors of S31 and S32. While the simple sum suits general-purpose application, the method that acquires the sum in a form resulting from attaching weight conforming to the degree of importance of the place is effective. When the dimensional control of the line width S31 fated to form a gate is important, for example, the precision of the necessary part is relatively improved by multiplying the value of S32 by a coefficient, such as 2 or 3.

### Second Embodiment

### (1) Explanation of Configuration and Process:

Another example of implementing fabrication of a semiconductor integrated circuit device using a mask designed by the method of this invention for designing a mask pattern will be described.

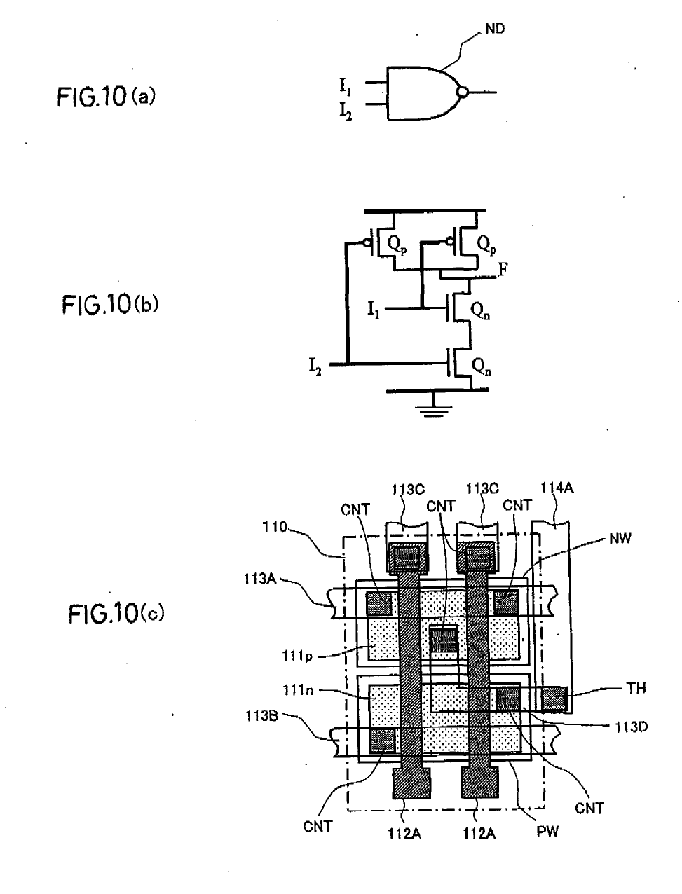

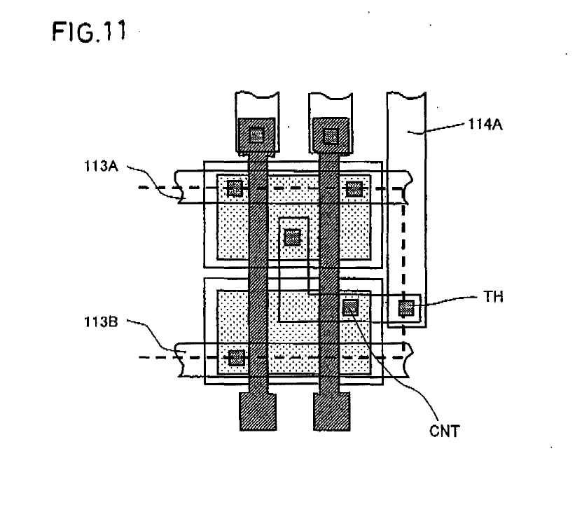

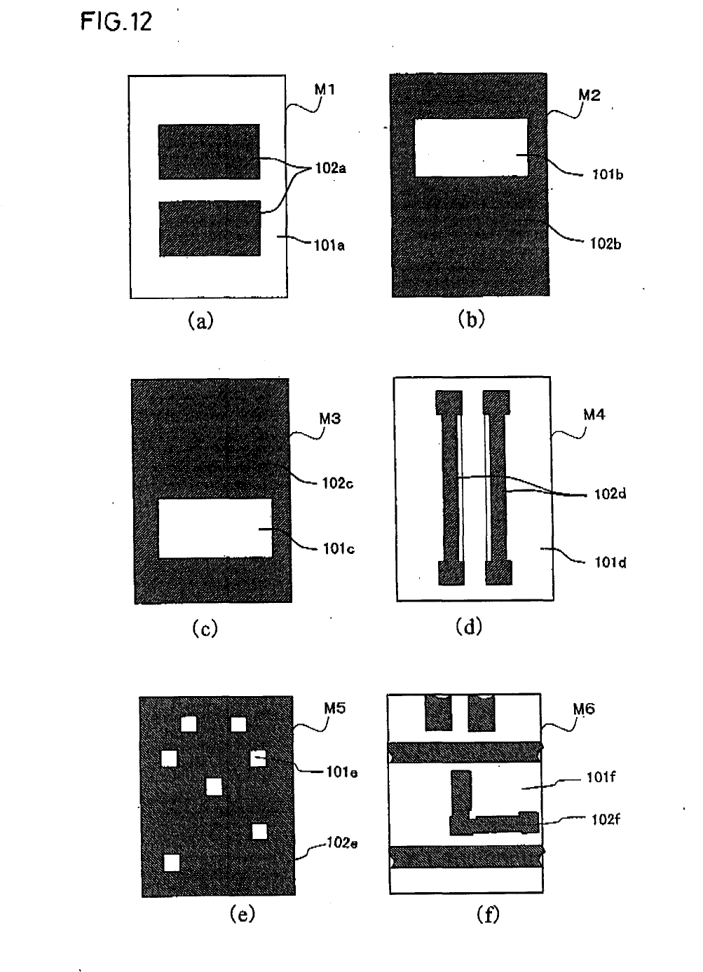

FIG. 10(a) to 10(c) illustrate a two-input NAND gate circuit ND, FIG. 10(a) depicting a symbol diagram, FIG. 10(b) a circuit diagram and FIG. 10 (c) a layout plan view. In FIG. 10(c), the part enclosed with an alternate long and short dash line is a unit cell 110, which is configured with two nMOS parts Qn formed on an n-type semiconductor region 111n of the surface of a p-type well region PW and two pMOS parts Qp formed on a p-type semiconductor region 111p of the surface of an n-type well region NW. For the purpose of making this structure, the pattern transcription by means of ordinary photolithography was repeated by sequentially using the masks M1 to M6 shown in FIG. 12(a) to FIG. 12(f). Of these masks, the masks M1 to M3 which had patterns of comparatively large sizes were not subjected to the OPC treatment of pattern. In the drawing, 101a, 101b and 101c denote light-transmitting pans and 102a, 102b and 102c denote light-blocking parts formed of chromium film. Since the masks M4 to M6 had fine patterns, they were optimized by suitably changing the contours and the sizes of the pattern figures in accordance with the method of this invention for designing a pattern. In the drawing, 101d, 101e and 101f denote light-transmitting parts and 102d, 102e and 102f denote light-blocking parts.

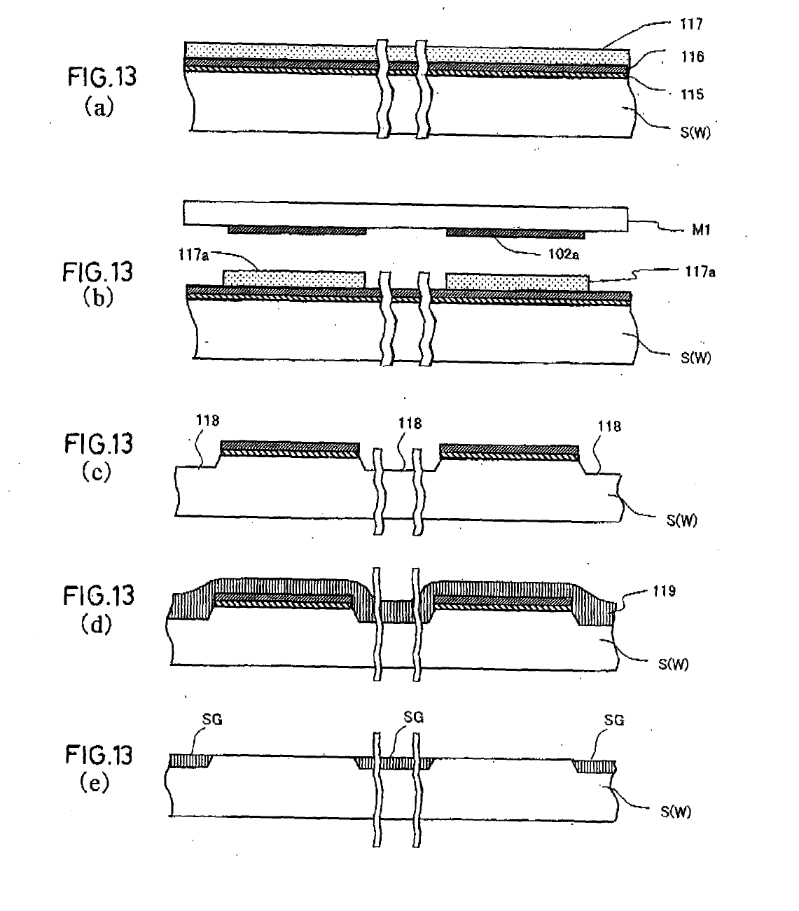

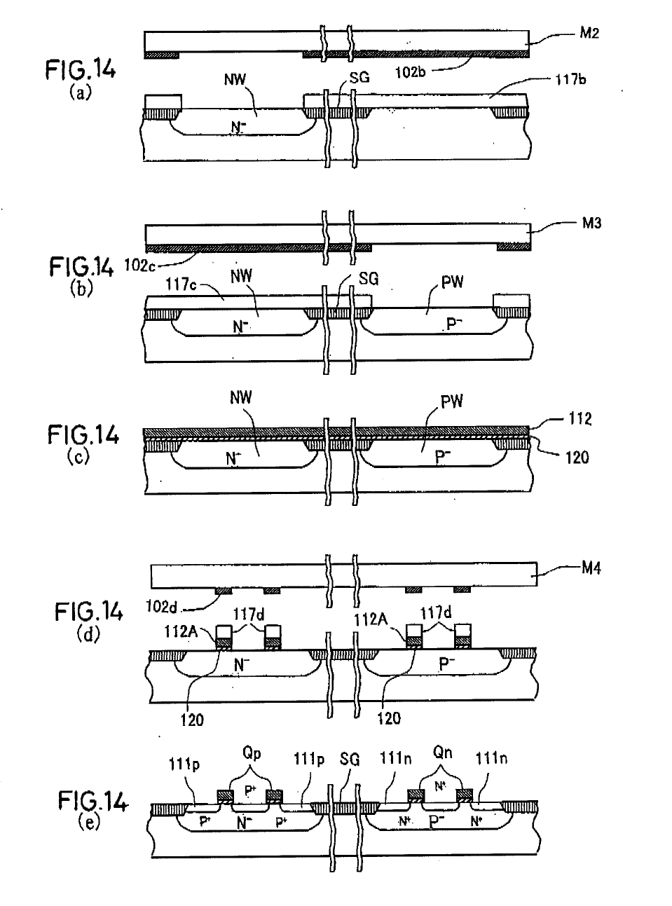

In FIG. 11 which depicts the same layout as in FIG. 10(c), a cross section lying along a broken line is assumed and the steps up to the step for forming channels Qp and Qn are shown sequentially in the order of occurrence in FIG. 13(a) to FIG. 13(e) and FIG. 14(a) to FIG. 14(e) by using the cross section. An insulating film 115 formed of a silicon oxide film, for example, was formed by the oxidizing method on a wafer S (W) formed of p-type silicon crystal, a silicon nitride film 116, for example, was deposited thereon by the chemical vapor deposition (CVD) method, and further a resist film 117 was formed thereon (FIG. 13(a)). Then, the treatment for exposure and development by using a mask M1 was carried out to form a resist pattern 117a (FIG. 13(b)). Thereafter, the resist pattern 117a was adapted to serve as an etching mask, the layers 115 and 116 exposed from the etching mask were sequentially removed, and the resist was further removed to form a groove 118 on the surface of the wafer S (W) (FIG. 13(c)). Then, an insulating film 119 formed of silicon oxide, for example, was deposited as by the CVD method (FIG. 13(d)) and a device separation structure SG was finally formed by carrying out the flattening treatment as by the chemical mechanical polishing (CMP) method (FIG. 13(e)). While the present embodiment formed the SG as a groove-type separation structure, this invention does not need to be limited to this embodiment. The SG may be configured with a field insulation film as by the local oxidation of silicone (LOCOS) method, for example.

Subsequently, the treatment for exposure and development using a mask M2 was carried out to form a resist pattern 117b. Since a region fated to constitute an n-type well region was exposed, the ions of phosphorus or arsenic were implanted therein to form an n-type well region NW (FIG. 14(a)). Similarly, a resist pattern 117c was formed by means of a mask M3 and then the ions of boron, for example, were implanted therein to form a p-type well region PW (FIG. 14(b)). Then, a gate insulation film 120 made of a silicon oxide film was formed in a thickness of 3 nm by the thermal oxidation method and a polycrystalline silicon layer 112 was deposited thereon as by the CVD method (FIG. 14(c)).

After the subsequent application of a resist, a gate insulation film 120 and a gate electrode 112A were formed by preparing a resist pattern 117d by means of a mask M4, etching the polycrystalline silicon layer 112, and removing the resist (FIG. 14(d)). Thereafter, channels Qp and Qn were formed by having source and drain regions and n-channel MOS n-type semiconductor region 111n and p-channel MOS p-type semiconductor region 111p both having a high impurity concentration and serving concurrently as wiring layers produced in a self-aligning state relative to the gate electrode 112 by the ion implantation or the diffusing method (FIG. 14(e)).

In the subsequent step, a group of two-input NAND gates were manufactured by suitably selecting a wiring. Needless to mention, NOR gate circuits and other circuits, for example, can be formed in this case by altering the wiring in shape. Here, examples of manufacturing two-input NAND gates by using masks M5 and M6 are illustrated respectively in FIG. 12(e) and FIG. 12(f).

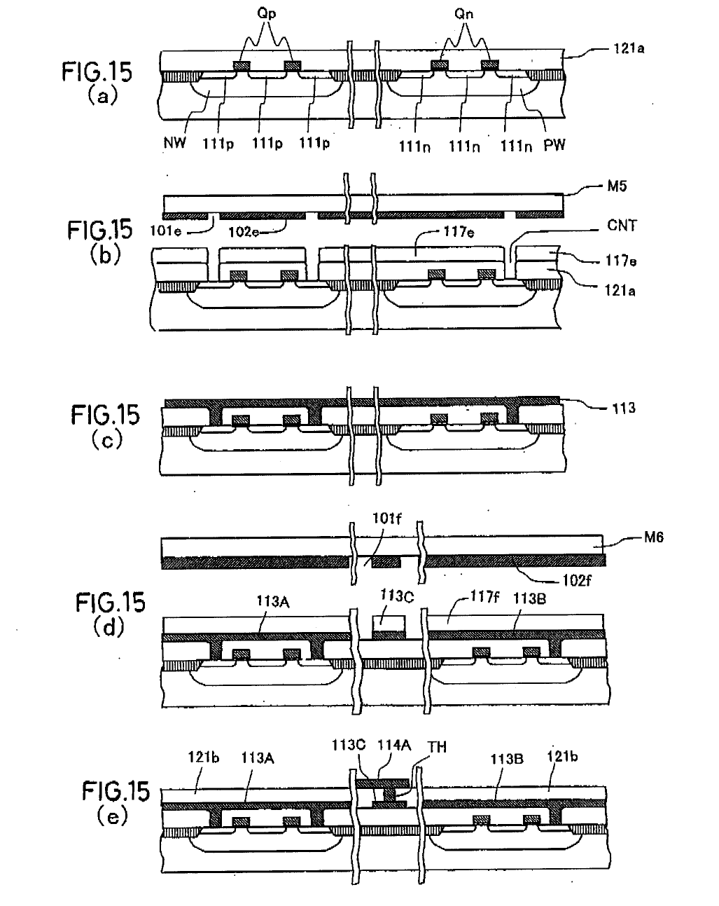

FIG. 15(a) to FIG. 15(e) depict cross sections taken along the broken line shown in FIG. 11 and illustrate collectively a process for forming a wiring. On two n-channel MOS parts Qn and two p-channel MOS parts Qp, an interlayer insulation film, such as an interlayer insulation layer 121a made of a phosphorus-doped silicon oxide film, was deposited by the CVD method (FIG. 15(a)). Subsequently, a resist was applied, a resist pattern 117e was formed by using the mask M5, and a contact hole CNT was formed by the etching treatment (FIG. 15(b)). After the resist was removed, a metal, such as tungsten, a tungsten alloy or copper, was embedded and further a metallic layer 113 of the embedded metal was simultaneously formed (FIG. 15(c)). Subsequently, a resist was applied and a resist pattern 117f was formed by means of the mask M6 and wirings 113A to 113C were formed by the etching treatment (FIG. 15(d)). Thereafter, an interlayer insulation film 121b was formed and a through hole TH and an upper-layer wiring 114A were formed by using still another mask (not shown) (FIG. 15(e)). The wire connection between the component parts was implemented by the pattern formation that was accomplished by repeating only the necessary part of the same steps. Thus, the manufacture of a semiconductor integrated circuit device was completed.

The application of the method of this invention described above enables manufacture of a semiconductor integrated circuit device by using a mask warranting pattern precision and ensuring high reliability.

A light-blocking pattern 102d in the mask M4 particularly among the aforementioned masks composing the cell library forms a gate pattern having the shortest size and allows a transcription pattern to exhibit the most exacting dimensional precision. Thus, the method of this invention was adopted when the cell library pattern shown in the mask 4 (FIG. 12 (d)) was disposed on the entire mask.

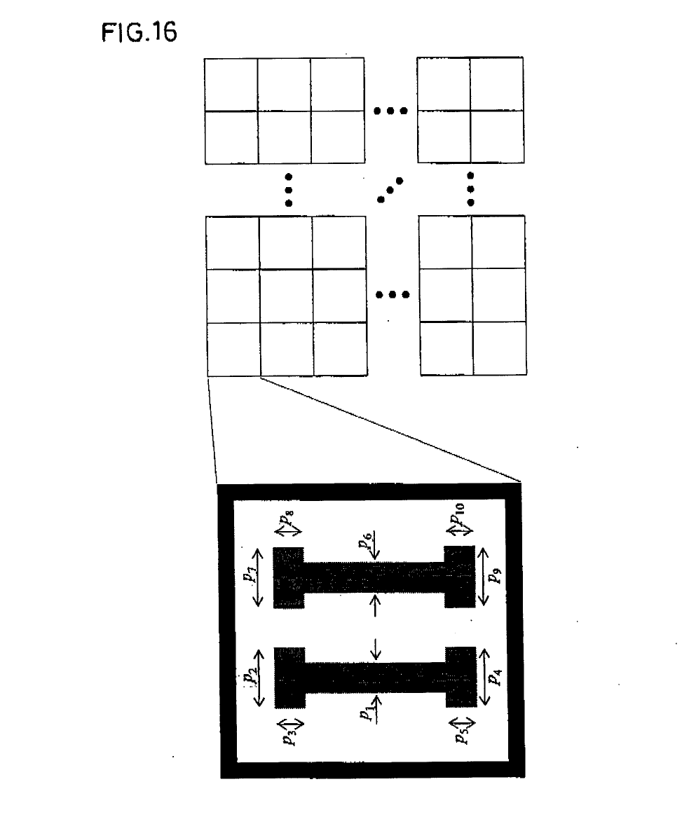

The whole of the mask pattern was composed of a plurality of cells, which individually had two I-shaped figures placed in a line (FIG. 16). The cells were individually provided with 10 portions of adjustment p₁ to p₁₀ as shown in the drawing. When the number of cells is assumed to be N_{cell}, all the mask patterns involved are required to prepare (N_{cell}×10) parameters.

### [Initialization: Definition of Coding of Chromosome]

In the present embodiment, the individual variables are handled as real numbers directly indicating the sizes of figures. Specifically, it is assumed that the component elements xᵢ (i=1, 2, . . . , 10) of the variable vector X are expressed with real numbers and that they correspond to pᵢ (i=1, 2, . . . , 10) in FIG. 16.

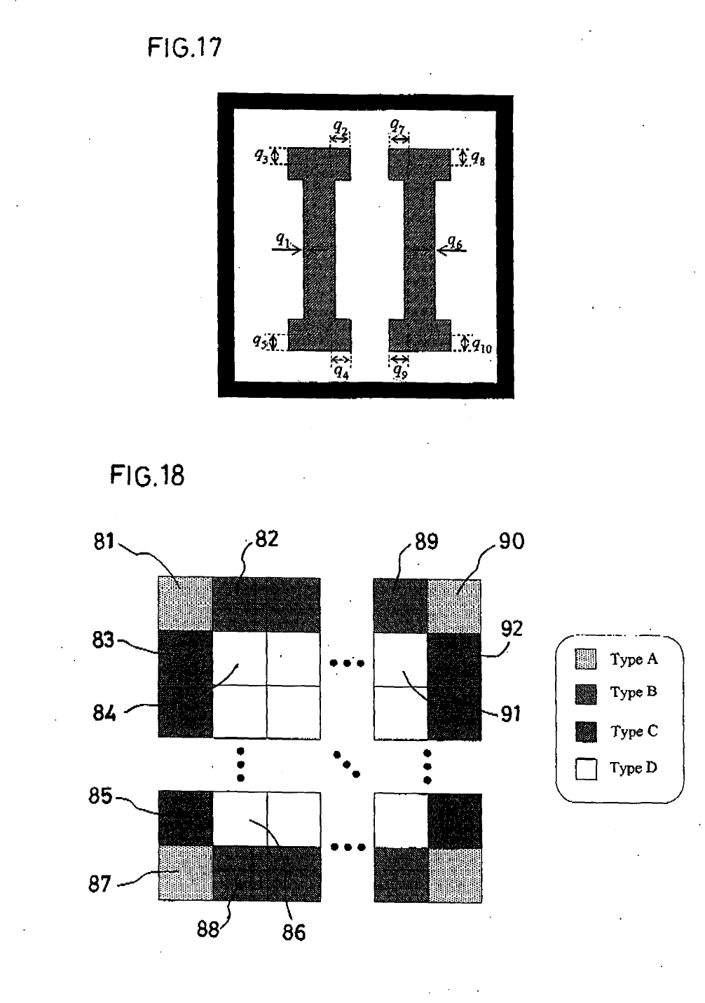

At this time, the differences from the design target may be expressed instead of directly using the values of the sizes. In the case of FIG. 17, for example, the figure filled with a half-tone dot meshing is a mask pattern that has undergone the OPC. The upper-side and the lower-side lateral bars of one of the I-shaped figures are imparted in vertical symmetry and bilateral symmetry relative to the design target indicated with an alternate long and short dot line and the vertical bars may have the thickness thereof altered in bilateral symmetry. The designation of the individual sizes q₁ (i=1, 2, . . . , 10) results in uniquely deciding the mask pattern. That is, by regarding the variable vector X=(q₁, q₂, . . . , q₁₀) as a chromosome, it is rendered possible to obtain the optimum mask pattern by the genetic algorithm.

Since the present mode of embodiment handles a mask pattern having N_{cell} cells of the same kind, the length of the chromosome becomes the product resulting from the multiplication with N_{cell}, i.e. X=(X¹, X², . . . , X^{Ncell})=(x¹₁, . . . , X¹₁₀, . . . , X^{Ncell}₁, . . . , X^{Ncell}₁₀). Here, it is assumed that X^{j} denotes a variable vector formed of ten elements for designating the shape of a figure contained in the j-th cell and x^{j}ᵢ denotes the i-th element of the variable vector corresponding to the j-th cell.

Further, the component elements xᵢ of the aforementioned variable vector may be expressed with n-adic numbers by deciding the upper-limit value, the lower-limit value, and the number of quantizing steps instead of being expressed with real numbers.

When the same cells are used as repeatedly disposed regularly as in the memory, the optimization can be facilitated by grouping the cells, thereby shortening the lengths of the chromosomes instead of subjecting all the variable vectors of all the cells to the search of the optimum values. In FIG. 18, for example, on the assumption that all the cells are formed of figure patterns of the same kind and that these figures are in bilateral symmetry and vertical symmetry, the same effect as adjusting the whole mask can be obtained by dividing all the variable vectors of all the cells into four kinds instead of subjecting them wholly to the optimization, optimizing only the variable vectors (X¹, X², . . . , X⁴) defining the figures of the four cells, and applying the results to all the cells grouped into types. In FIG. 18, for example, a cell 81 lacks the five neighboring cells on the upper side and the left side in the total of eight surrounding cells and allows the presence of three cells 82, 83 and 84 on the right side and the lower side. Then, a cell 90 and the cells surrounding it (89, 92 and 91) are disposed in bilateral symmetry and a cell 87 and the cells surrounding it (88, 85 and 86) are disposed in vertical symmetry relative to the cell 81 and the cells surrounding it (82, 83 and 84). As a result, the result of the optimization of the cell 81 can be used for the cell 90 and the cell 87. Thus, the process for adjusting the optimization can be omitted.

### [Initialization: Design of Evaluation Function]

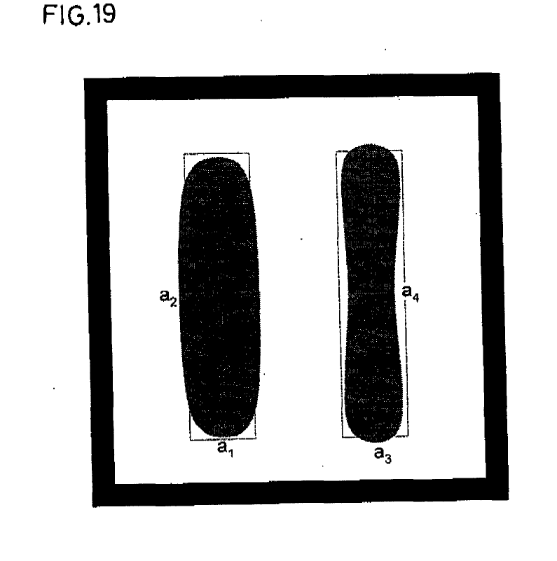

As a method for obtaining the degree of fitness of a chromosome, the present embodiment adopt the same procedure as in the first embodiment, with the exception that the measurement of sizes in Step (3) was executed at the four portions shown in FIG. 19. In the fabrication of an ordinary semiconductor chip, the parts that do not tolerate the slightest error and the parts that avoid urging precision are intermingled. Thus, the optimization reflecting the intention of the designer of the mask can be facilitated by subjecting the parts requiring high precision selectively to the dimensional measurement and executing the calculation of the degree of fitness. Similarly, when the portions apt to reveal the optical proximity effect can be specified, the optimization can be facilitated preferentially by exerting a large weight to the portions that are difficult of adjustment during the calculation of the degree of fitness.

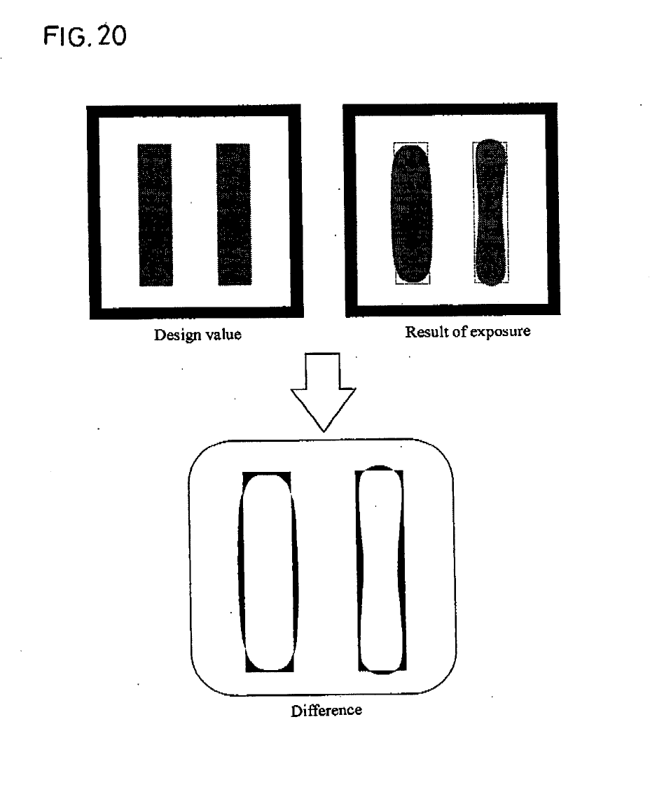

The present embodiment contemplates measuring sizes of several portions during Step (3) for calculating the degree of fitness for the purpose of comparing the resist pattern predicted by simulation with the design pattern. By using the surface areas of the differential images of the resist pattern and the design pattern as shown in FIG. 20, it is rendered possible to effect infallible detection of the unexpected abnormalities at the portions that have shunned dimensional measurement. In this case, the optimization of a parameter by the genetic algorithm can be executed by using the reciprocals of the surface areas of the differential images as the evaluation value.

The reciprocals of the sums of errors were adopted as the degrees of fitness in Step (4) for calculating the degree of fitness. Optionally, the values of subtraction of the sum of errors from a predetermined constant value may be used as the degrees of fitness.

Further, by additionally performing simulation of acid diffusion at Step (2) for calculation the degree of fitness, the precision of the optimization can be enhanced because the resist pattern can be predicted more accurately.

### [Initialization: Formation of Population of Initial Chromosomes]

The population of initial chromosomes was randomly formed similarly to the first embodiment. This formation may be started from the initial population that has resulted from exerting a minute perturbative approach to the result corrected by the model base OPC for the purpose of enhancing the speed of search

### [Evaluation of Chromosome]

All the chromosomes were evaluated and tested for the degree of fitness in accordance with the procedure for evaluating a chromosome decided in the preceding section “Initialization: Design of evaluation function,” similarly to the first embodiment.

### [Formation of Population of Next Generation: Selection]

The method of roulette selection was used similarly to the first embodiment. The generation alteration model, such as the crossover method like the method of tournament selection or the method of rank selection or the minimal generation gap (MGG) method, may be used (reference: Sato et al. “A New Generation Alternation Model of Genetic Algorithms and its Assessment,” Journal of Japanese Society for Artificial Intelligence, Vol. 12, No. 5, 1997),

### [Formation of Population of Next Generation: Crossover]

The uniform crossover was used similarly to the first embodiment. Besides, the value obtained by the weighted average of the randomly selected gene loci may be used instead of the exchange of the loci.

For the purpose of enhancing the speed and the precision of search, the unimodal normal distribution crossover (UNDX) that is a crossover method developed to suit the chromosome expressed with a real number, or the simplex crossover, or the extrapolation-directed crossover (EDX) may be used (reference: Sakuma et al., “Optimization of nonlinear function with the value GA of real number: Problems in higher dimensioning of search space and method for solution thereof,” the 15^{th} national convention of Japanese Society for Artificial Intelligence, the 2^{nd} AI Meeting of Youth Community MYCOM2001, 2001).

When a chromosome is expressed with a two-valued vector, the multipoint crossover may be used besides the uniform crossover.

### [Formation of Population of Next Generation: Mutation]

The mutation using random numbers formed in accordance with the normal distribution was used similarly to the first embodiment. For the purpose of enhancing the speed and the precision of search, the adaptive mutation method, that monitors the speed of enhancing the degree of fitness of the whole population and temporarily increases the ratio of mutation when no enhancement appears over a prescribed duration, may be additionally used.

### [Criteria for Terminating Search]

The search was terminated when the error from the design value reached 0 or a value below a fixed level or when the number of evaluations of a chromosome exceeded a prescribed value similarly to the first embodiment.

The genetic algorithm used in the present embodiment has been described in the foregoing. The speed and the precision of search can be enhanced by additionally using other methods of search, such as the hill climbing method, the simplex method, the steepest descent method, the simulated annealing method and the dynamic programming method. The furthering of the enhancement of the speed of search and the enhancement of the precision of search can be realized by choosing blind search methods and the method of probability, such as the evolution strategy (ES), the genetic programming (GP) and so on besides the genetic algorithm.

Since the preceding embodiment fabricates a semiconductor chip using the cell library having undergone the OPC treatment and optimizes it utilizing the genetic algorithm capable of quickly disposing of the influence of the surrounding cell libraries, it can reduce the time of process to less than one tenth as compared with the conventional method that performs the OPC treatment on all the patterns.

### Third Embodiment

A system LSI provided with a SRAM part and a logical circuit part was fabricated using the method for forming a mask pattern that is described in the first embodiment. In this LSI, the smallest gate width was 40 nm and the smallest pitch was 160 nm. The logical circuit part allowed an optional pitch wiring and imposed no other restriction of layout than the minimum gap between the cells. Thus, the layout rule consequently established allows inheritance of the conventional IP, promises substantial development as platform, and proves applicable to numerous varieties.

When a pattern for dimensional correction is formed by the rule-based OPC under the loose layout rule mentioned above, partial dispersion occurs in the dimensions of a gate pattern within the active region. The basal part near the pad sustains a constriction or a swell, which induces deterioration of the special quality of the device. The dispersion is also at a disadvantage in allowing only a small exposure margin to the variation of the amount of exposure or to the variation of focus and revealing inferiority of the yield of a semiconductor device. When the pattern for producing a mask is formed by the commercially available model-based OPC, the formation takes a long time, such as seven days.

The system LSI is directed to a special user, has a short product cycle and is required to be fabricated within a short duration. This duration constitutes a lifeline, which dominates not merely the value as a device but also the marketability of a product incorporating the device. When this system is preferentially processed using a single-wafer processing, the duration of the wafer process is at least two weeks and the mask supply is expedited. Heretofore, for the purpose of enabling the duration for forming a mask-producing pattern to fall in the neighborhood of one day as a practical size, the partial application of the rule-based OPC is the only solution available at all and is suffered to entail such problems as deteriorating the yield as described above. By applying the method for forming a mask pattern that is described in the first embodiment, it is rendered possible to shorten the time required for forming a mask pattern to one day and moreover obtain the same special quality of device and the same yield as when the model-based OPC is applied to the whole surface. Incidentally, the application of the single-wafer processing to the wafer process produces such effects as decreasing the waiting time of the wafer process, balancing the wafer process with the speed of supply of the mask and advancing the time for shipping the system LSI.

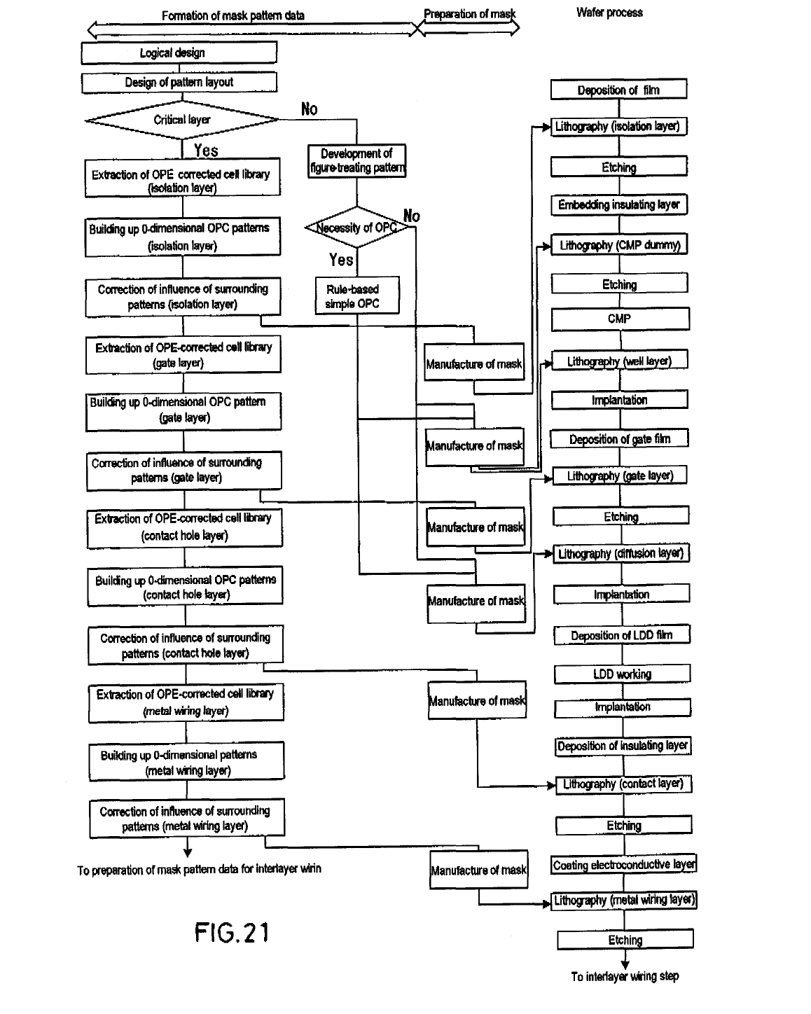

The foregoing description will be further explained below by reference to FIG. 21. FIG. 21 illustrates the preparation of a mask pattern data for the system LSI, the manufacture of a mask and the process for manufacturing a wafer in the form of a flowchart. The step for preparing the mask pattern data is depicted on the left side, the step for manufacturing a mask in the center, and the process for fabricating the wafer on the right side.

The fabrication of LSI starts after completion of the pattern layout design based on the logical design. The wafer process flow comprises the deposition of film for producing isolation (separation between active regions), the lithography, the etching, the embedding of an insulating film, the lithography for manufacturing a CMP dummy pattern directed to further surface smoothing, the etching and the CMP, thereby forming an isolation. Thereafter, a gate is formed by performing the lithography for dividing the implantation, the formation of a well layer by implantation, the deposition of a film for a gate, the lithography, the etching, the lithography for diving the implantation, the implantation, the deposition of a film for the LDD, the working of the LDD, and the implantation. Thereafter, a wiring layer is formed by performing the deposition of an insulating film, the lithography for forming a contact hole, the etching for perforating a through hole, the formation of an electroconductive film, and the lithography and the etching. Subsequently, an interlayer wiring is formed by carrying out the formation of an interlayer insulation film and the formation of an opening, the coating of the electroconductive film, and the CMP.

The mask is required to be prepared so as to conform to the wafer process flow. In broad classification, the mask is known in two types, one for use in a critical layer necessitating dimensional precision and the other for use in a noncritical layer. The former necessitates an OPC involving an enormous amount of data. For the latter, a simplified OPC, a simple graphic operation, or the data itself suffices. The critical layer is represented by isolation, gate, oontact, and first and second wirings.

The mask pattern OPC data first enters the fabrication procedure after it has been examined to determine whether it is a critical layer or not. For the start, the necessary isolation is prepared. Then, the patterns proving satisfactory are extracted from the cell library already completed for the correction of optical proximity effect (OPE) and these patterns are combined to build up a pattern that has undergone the 0-dimensional OPC. Then, a final OPC pattern is prepared by carrying out the correction based on the genetic algorithm method of the first embodiment in due consideration of the influence of the surrounding patterns and the mask is manufactured based on the data. Then, the pattern data and the mask for a gate layer, a contact layer and a wiring layer are prepared by the same method. Here, the procedure for preparing the component layers serially is illustrated. Optionally the component layers may be prepared parallel to one another. In the case of the parallel form, however, the production of a data necessitates a plurality of systems and entails substantial addition to the equipment. The system adapted to allow the component layers to be treated serially and enable the speed of treatment to conform to the timing of the wafer process is at an advantage in warranting miniaturization. The noncritical layer prepares the mask pattern data by using a separate path as described above.

Since the isolation layer that is a critical layer has an extruded head, a delay in the preparation of the mask thereof immediately results in retarding the discharge of a wafer. Thus, the duration for completing the mask pattern data of the isolation layer is exceptionally important. The present embodiment completed the preparation inclusive of the manufacture of a mask in one day, which allowed halving the ordinary duration of two days.

In a broad breakdown, nine steps precede the next lithography for the gate layer. Minutely, about 50 steps (not shown) including even insignificant steps for cleaning are involved. They can be nevertheless completed in two days when the single-wafer processing is performed. When the mask for the gate layer is not prepared in this while, the waiting that inevitably takes place induces a loss. Since the gate demands extremely high dimensional precision, the conventional method requires about one day for the lithography and inspection of a mask and seven days for preparing a mask pattern data. Thus, in the case of the conventional method, even when the equipment for forming a data is enlarged and the formation of a data is started parallel with the formation of an isolation pattern, it is extremely difficult to prepare a mask pattern data so as to catch up with the speed of the wafer treatment. In contrast, the present embodiment enabled preparing a mask pattern data in one day even with small equipment for forming a pattern data.

Since the gate pattern demands high dimensional precision, the rule-based OPC incurs difficulty in thoroughly securing the device characteristic but the model-based OPC complicates a treatment and consequently entails the problem of necessitating an enormous amount of time for the formation of a gate pattern. This problem is more serious than in the case of other layers. Thus, the method of production in the present embodiment is effective particularly in the formation of a gate pattern.

### Fourth Embodiment

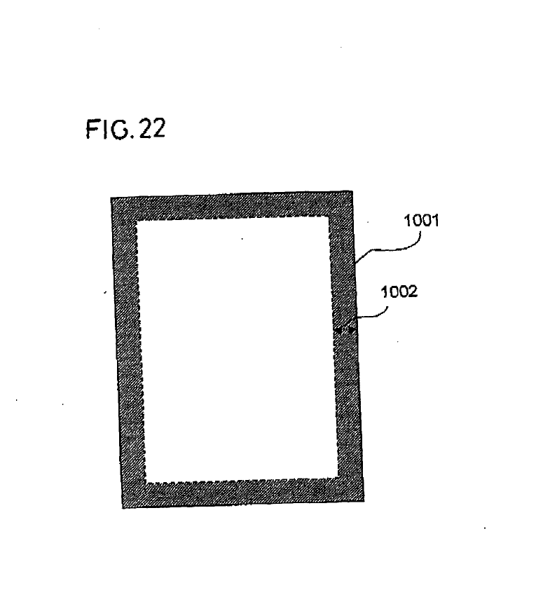

Another embodiment of the variable to be prepared by this invention is illustrated here. In FIG. 22, reference numeral 1001 denotes a cell of the cell library aimed at. The pattern to be formed therein has undergone the OPC on the single cell base. The region in the cell that contains a pattern subjected to the correction of OPC by the influence of the surrounding environment is a hatched peripheral region. The width 1002 of this region is about 2λ/NA, depending on the exposure wavelength λ of the exposure device, the numerical aperture NA of the lens used, the acid diffusion constant of the resist used and the standard dimensional precision.

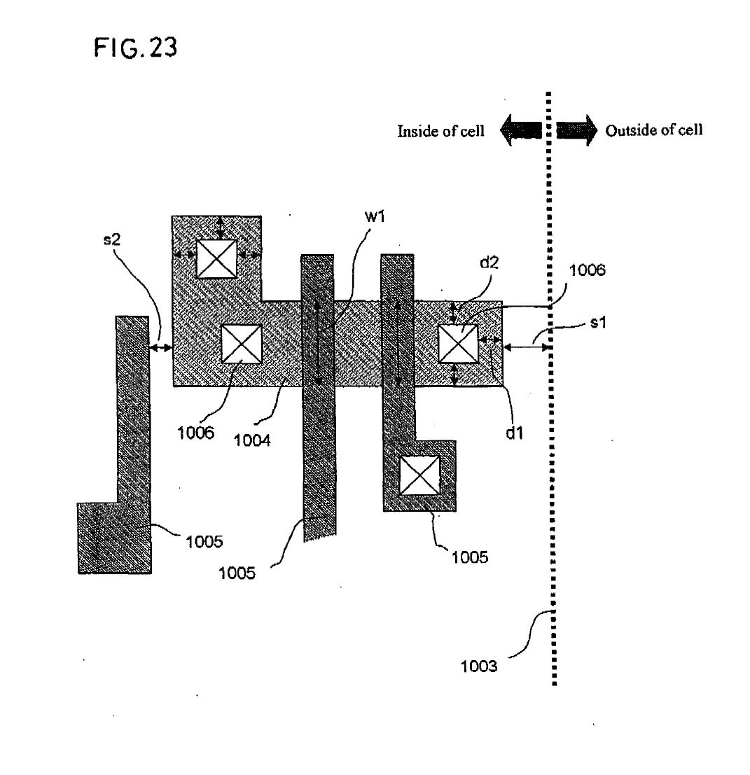

An example of the pattern layout that is present in this peripheral region is illustrated in FIG. 23. In the figure, reference numeral 1003 denotes a cell part boundary region, numeral 1004 an active region (diffusion layout region), numeral 1005 a gate and a gate wiring, and numeral 1006 a through hole (generally referred to as “contact”). The outside of the active region 1004 is an insulating region against a semiconductor substrate called a “field.” It is a region called “isolation.” By reason of the relation with the disposal of a cell and a cell, the part that comes to necessitate the treatment of correction after undergoing the OPC treatment performed on the cell unit will be described below as divided into an active layer (isolation layer), a gate layer and a contact layer.

### [Isolation Layer]

In FIG. 23, a gate width w1, contact-diffusion layer matching allowances d1 and d2, an allowance s1 for evading failure of resolution (failure of pattern connection) with the neighboring cells, and an allowance s2 for evading failure of the running of the gate wiring aground the diffusion layer are the regions for the repeated OPC adjustment. When the gate width w1 fails to satisfy the standard precision, the special quality of a transistor is deteriorated by the narrow-channel effect. In the absence of the contact-diffusion layer matching allowances d1 and d2, the failure of continuity is induced by an increase in the contact resistance.

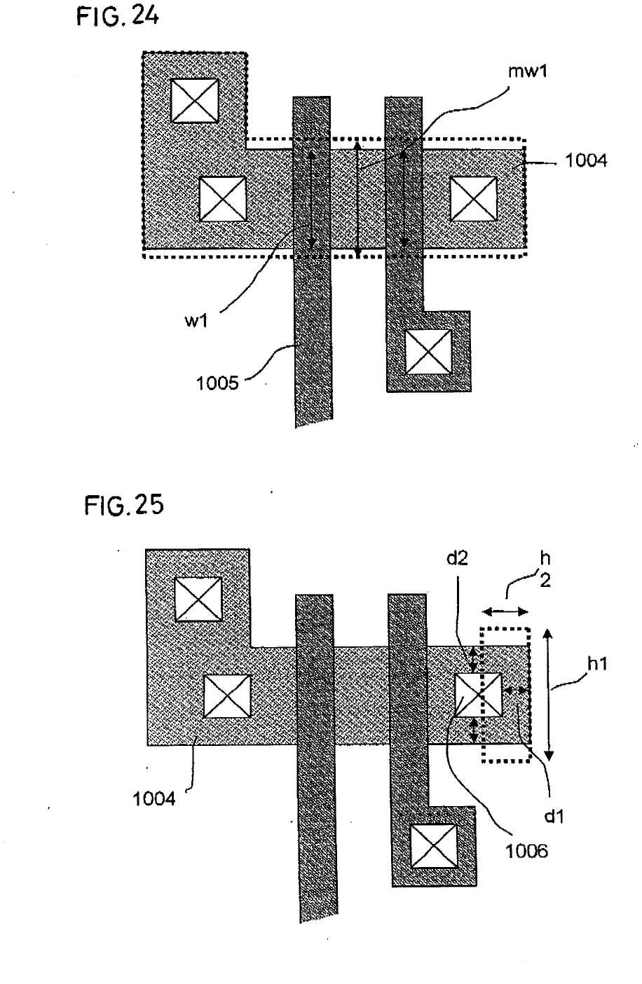

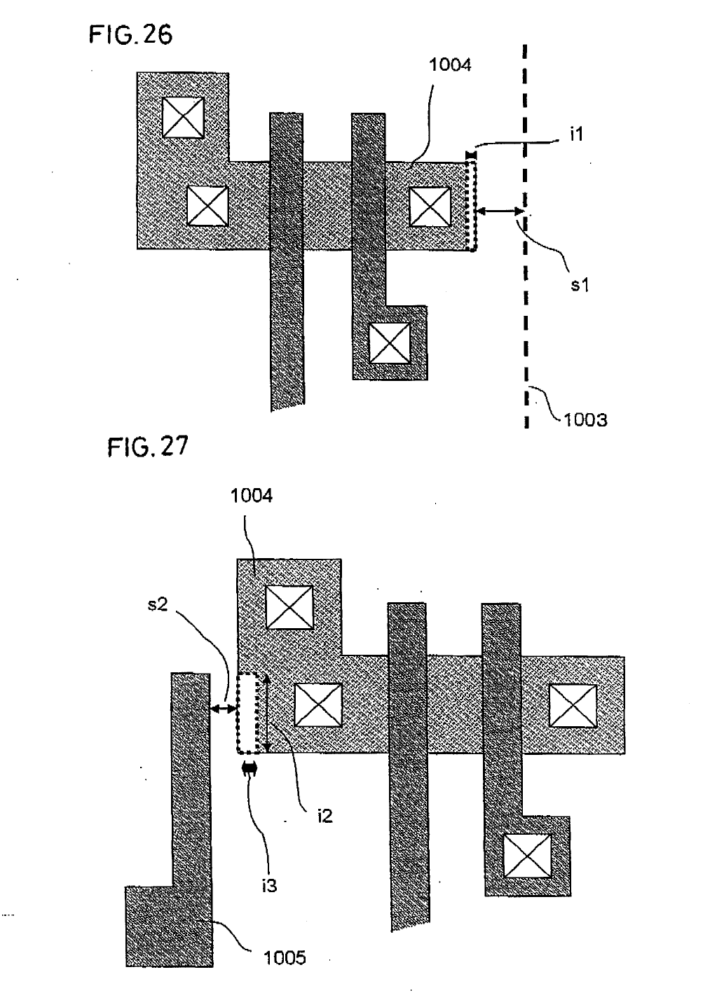

Examples of the variable of the active region requiring adjustment will be described below by reference to FIG. 24 to FIG. 27. FIG. 24 illustrates an actual example of the adjustment variable of the gate width w1, which adjusts the width mw1 by using the genetic algorithm method. FIG. 25 illustrates an actual example of the adjustment variable for the contact-diffusion layer matching allowances d1 and d2, which deforms the edge of the diffusion layer into the form of a hammer head having a width h1 and a length of h2 and adjusts the deformed edge by using the genetic algorithm method, FIG. 26 illustrates an actual example of the evasion of the failure of resolution with the neighboring cells (failure of pattern connection), which uses the amount of retraction of the distal end of the active region 1004 as a variable i1. FIG. 27 illustrates an example of the evasion of the failure of the running of the gate wiring aground the diffusion layer, which uses a length i3 and a width i2 of the retracted region of the part opposed to a gate wiring 1005 as variables. These variables are adjusted by using the genetic algorithm.

### [Gate Layer]

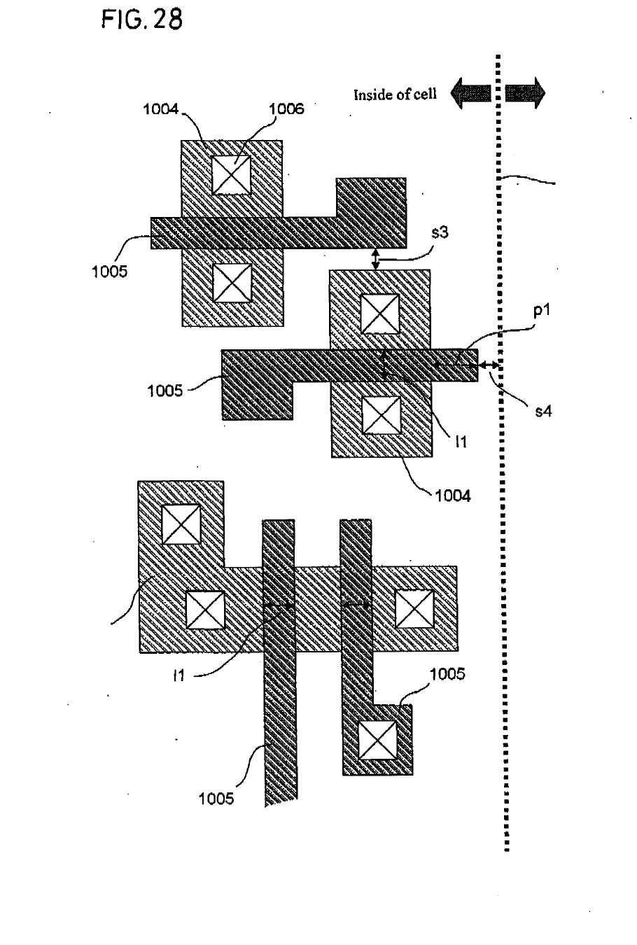

In FIG. 28, a gate length l1, an allowance s4 for evading the failure of resolution with the neighboring cells (failure of pattern connection), an allowance s3 for evading the failure of the running of the gate wiring aground the diffusing layer, and an amount of protrusion p1 from the active region are the portions that are subjected to the repeated OPC adjustment. The failure of the gate length l1 to satisfy the standard precision results in rendering the circuit operation instable because the control of the threshold voltage of the transistor is not attained as required and the transistor characteristic is largely dispersed.

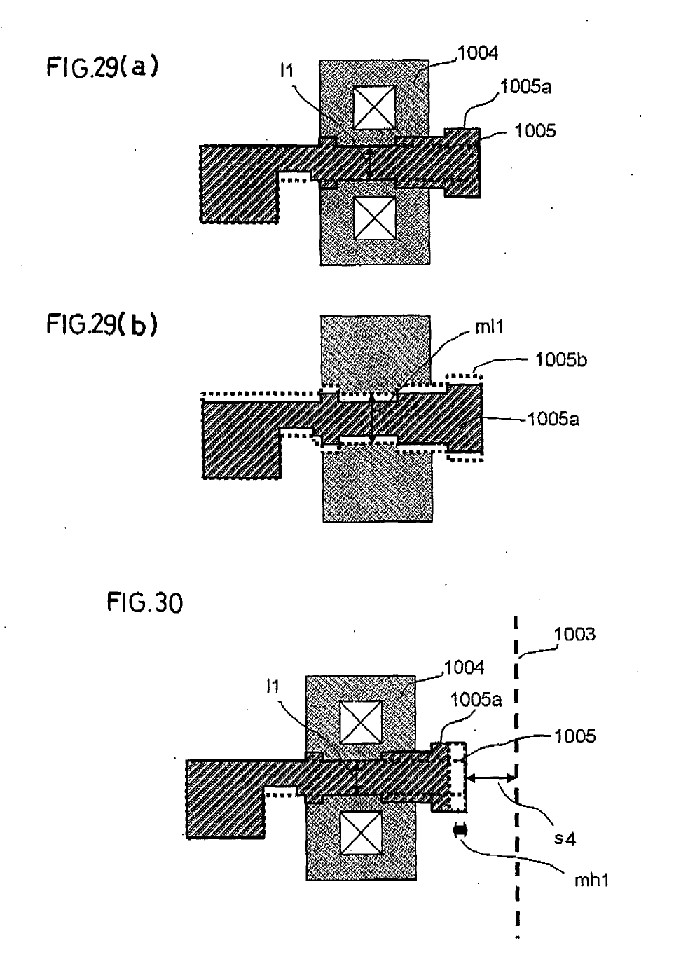

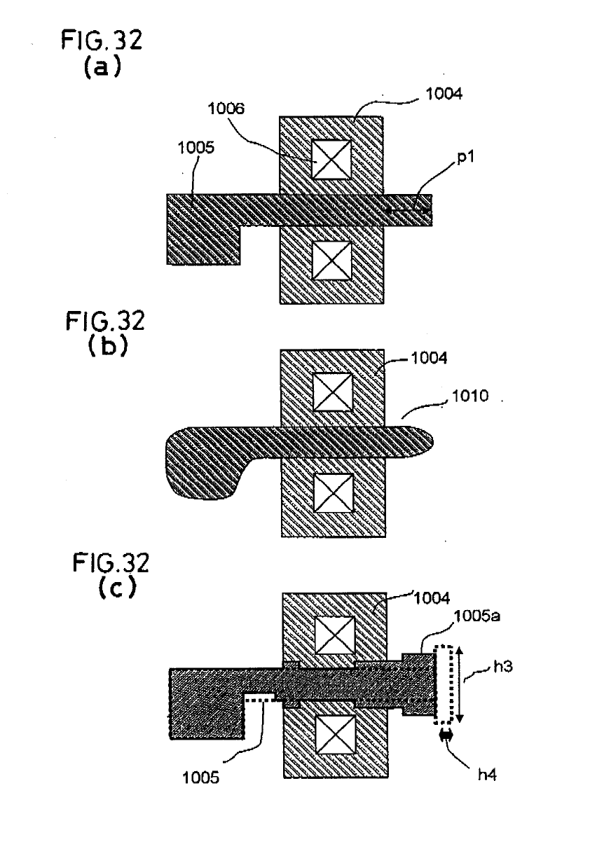

Examples of the variable that the gate and the gate wiring pattern are required to adjust will be described below by reference to FIG. 29(a), FIG. 29(b) and FIG. 32(a) to FIG. 32(c).

FIG. 29(a) and FIG. 29(b) illustrate examples of the adjustment variable for the gate length l1. Since the gate length is a dimension that influences the transistor characteristic most sensitively, it is required to possess particularly high dimensional precision. Generally, since a pad for establishing continuity with the wiring layer is formed in part of the gate wiring, the transcription pattern is deformed by the influence of the light diffracted from that part. For the purpose of preventing this deformation at least on the active region, the region is subjected to the complicated OPC as indicated at 1005a in FIG. 29(a). Here, the cell in the single form is first subjected to the OPC in advance so as to acquire the dimensional precision aimed at. Thereafter, the outer shape of the OPC is retained intact as illustrated in FIG. 29(b) and adjusted by using the genetic algorithm, with the line width ml1 as a variable, by reference to the other cell pattern disposed peripherally.

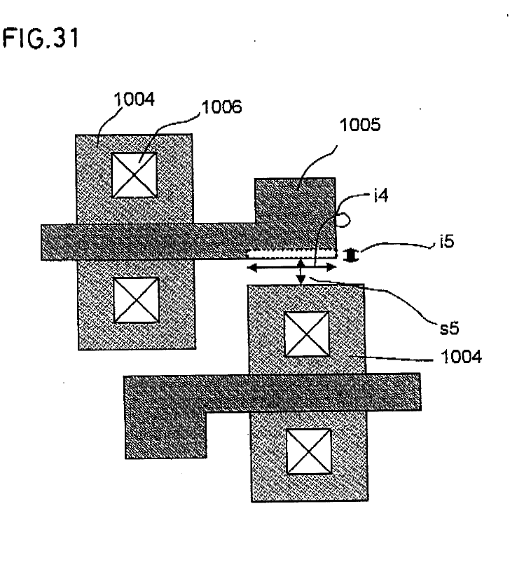

FIG. 30 illustrates an example of evading the failure of resolution (failure of pattern connection) with the neighboring cells, in which the amount of retraction mh1 of the distal end of the gate wiring pattern 1005a subjected to the OPC in the case of the cell in the single form is a variable. FIG. 31 illustrates an example of the evasion of the failure of the gate wiring running aground the diffusion layer, in which the variables are a width i4 and a depth is of the retracted part of the gate wiring opposed to the diffusion layer (active layer) 1004.

FIG. 32(a) to FIG. 32(c) illustrate examples of the correction of the projection from the active region. While the design layout is a rectangular layout as illustrated in FIG. 32(a), the actual pattern transcription causes the pattern edge to assume a rounded shape as illustrated in FIG. 32(b) owing to the effect of the diffraction of the exposure light and the acid diffusion of the resist. When the rounded part hangs on the active region, the transistor characteristic is deteriorated by the phenomenon of punch through. Thus, the projection in an amount exceeding a stated level must be secured. In this case, a hammer head that has a width h3 and a length h4 as illustrated in FIG. 32(c) is used as the variable. These variables are adjusted by using the genetic algorithm mentioned above.

### [Contact Layer]

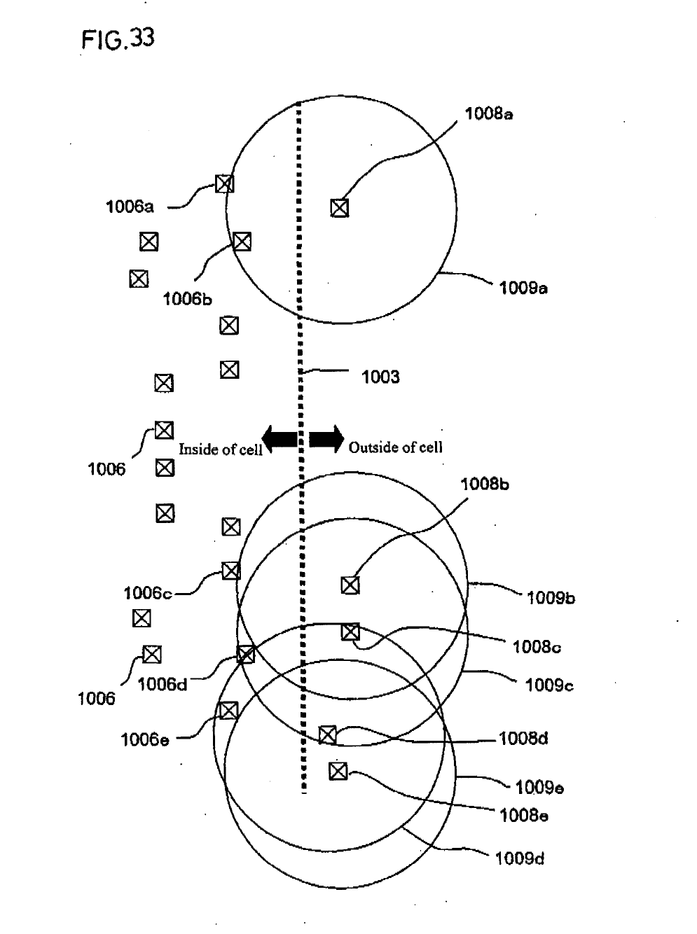

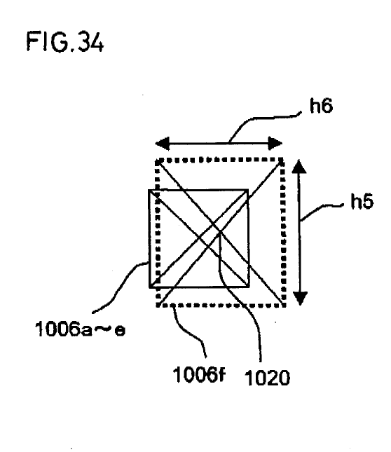

FIG. 33 illustrates an example of the layout of a contact layer. The patterns for correcting the OPC in consequence of the exertion of the influence of the outer cell are the patterns extending from the patterns 1008a to 1008e of the outer cell through the interaction regions 1009a to 1009e, which are denoted by 1006a to 1006e in the figure. The radius of these interaction regions is about 2λ/NA, depending on the acid diffusion constant of the resist and the standard dimensional precision. As illustrated in FIG. 34, the variables of the patterns 1006f subjected to the repeated OPC are a height h5 and a width h6 and the center position 1020 of the pattern is subjected as a variable to the correction of positional deviation. These variables are adjusted by using the genetic algorithm mentioned above.

### INDUSTRIAL APPLICABILITY

As described in the foregoing, the use of the method and the apparatus of this invention for designing a mask pattern in the optical proximity correction of photolithography results in expediting and facilitating the design of a mask pattern of the large-scale integrated circuit in the method for fabricating a semiconductor device. Since the mask pattern can be manufactured speedily and inexpensively, it is rendered possible to enable efficient manufacture of the large-scale integrated circuit, suppress the occurrence of a trouble, such as disconnection in the large-scale integrated circuit to be manufactured, consequently enhance the reliability and improve the yield as well.

Further, the fact that the time for designing a mask pattern is curtailed roughly by one decimal place from the time prevalent heretofore enables the custom IC that makes use of a large amount of mask patterns to attain a cut of cost and brings about an effect of widening the field of applications in the industry. For example, the development of a system LSI directed to digital information home electric appliances issuing from the high-mix low-volume production can be coped with at a low cost.

1. A method for designing a mask pattern, comprising the steps of acquiring cell libraries having undergone a treatment of optical proximity correction directed to correcting a change of shape taking place during formation of a pattern by exposure of a mask pattern to light, laying out the cell libraries to design a mask pattern and changing an amount of the optical proximity correction given to cells in consideration of an influence of surrounding cell patterns.

2. A method for designing a mask pattern according to claim 1, wherein the step of designing the mask pattern comprises a step of defining and registering a variable to be adjusted for the purpose of implementing the optical proximity correction.

3. A method for designing a mask pattern according to claim 2, further comprising the steps of comprehending a degree of influence of surrounding patterns and optimizing the variable, thereby correcting the cell libraries.

4. A method for designing a mask pattern according to claim 3, wherein the step of optimizing the variable is effected by the genetic algorithm method.

5. A computer program consisting of an algorithm possessing a function of executing the method for designing a mask pattern according to any one of claims 1 to 4.

6. A semiconductor device fabricated using the mask pattern formed by the method for designing a mask pattern according to any one of claims 1 to 4.

7. A method for manufacturing an electronic circuit device, comprising the step of using the mask pattern formed by the method for designing a mask pattern according to any one of claims 1 to 4.

8. A method for designing a mask pattern set forth in any one of claims 1 to 4, further comprising the step for changing a peripheral region of a single cell having undergone the process of optical proximity correction in consideration of an influence of peripherally disposed cell library patterns.

9. A method for fabricating a semiconductor device, comprising the step of using a mask pattern whose gate pattern has been corrected by the method for designing a mask pattern according to any one of claims 1 to 4.

10. A method for fabricating a semiconductor device according to claim 9, wherein the gate pattern has an adjusting variable that is a gate width and/or a gate length.

11. A method for fabricating a semiconductor device, comprising the step of using a mask pattern whose isolation-forming pattern has been corrected by the method for designing a mask pattern according to any one of claims 1 to 4.

12. A method for fabricating a semiconductor device according to claim 11, wherein the isolation-forming pattern has an adjusting variable that is a width of a diffusion layer region, an amount of retraction, an amount of projection or a combination thereof.

13. A method for manufacturing a semiconductor device, comprising the step of using a mask pattern whose contact pattern has been corrected by the method for designing a mask pattern according to any one of claims 1 to 4.

14. A method for fabricating a semiconductor device according to claim 13, wherein the contact pattern has an adjusting variable that is a height, a width and a central position.

15. A method for fabricating a semiconductor device, comprising the steps of using a mask pattern formed by the method for designing a mask pattern according to any one of claims 1 to 4 and using a single-wafer processing.
